(19) United States
(12) Patent Application Publication
(10) Pub. No.: US 2007/0092005 A1
(43) Pub. Date: Apr. 26, 2007

(54) Method and apparatus for encoding, method and apparatus for decoding, program, and storage medium

(75) Inventors: Tetsujiro Kondo, Tokyo (JP); Tomohiro Yasuoka, Tokyo (JP); Sakon Yamamoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/580,155

(22) Filed: Oct. 13, 2006

(30) Foreign Application Priority Data
Oct. 20, 2005 (JP) 2005-306093
Oct. 5, 2006 (JP) 2006-274200

(51) Int. Cl. H04N 7/12; H04N 11/02

(52) U.S. Cl. 375/240.14; 375/240.16

(57) ABSTRACT

An encoding apparatus is configured to encode input image data including a plurality of frames. The encoding apparatus includes a prediction coefficient generator adapted to generate a prediction coefficient for use in prediction of a second frame from a first frame, an image predictor adapted to generate a predicted image from a third frame by using the prediction coefficient, a residual generator adapted to determine a residual component between a current frame to be encoded and the predicted image, and an output unit adapted to output the residual component in the form of encoded data, wherein the first to third frames are frames which occurred as frames to be encoded, before the occurrence of the current frame.

### CROSS REFERENCES TO RELATED APPLICATIONS

The present invention contains subject matter related to Japanese Patent Application JP 2005-306093 filed in the Japanese Patent Office on Oct. 20, 2005, the entire contents of which are incorporated herein by reference.

### BACKGROUND OF THE INVENTION

1. Field of the Invention

The present invention relates to a method and apparatus for encoding, a method and apparatus for decoding, a program, and a storage medium, and more particularly, to a method and apparatus for encoding, a method and apparatus for decoding, a program, and a storage medium, which allow it to efficiently perform a prediction process thereby reducing amount of information associated with the prediction.

2. Description of the Related Art

Encoding can be performed according to one of two methods: a lossless encoding method and a lossy encoding method. In the lossless encoding method, data is encoded in a form that can be decoded into an original form. On the other hand, in the lossy encoding method, when data is encoded, some information is lost, and thus encoded data cannot be decoded into a perfect original form.

Examples of lossless encoding methods may be found, for example, in Japanese Unexamined Patent Application Publication No. 2000-092328 or Japanese Unexamined Patent Application Publication No. 2000-299866. In the lossess encoding methods disclosed in Japanese Unexamined Patent Application Publication No. 2000-092328 and Japanese Unexamined Patent Application Publication No. 2000-299866, pixels to be used in prediction are selected in accordance with feature values of pixels in the vicinity of a pixel of interest, and prediction is performed using the selected pixels.

On the other hand, in encoding methods disclosed in Japanese Examined Patent Application Publication No. H07-046868, Japanese Patent No. 3543339, and Japanese Unexamined Patent Application Publication No. H08-084336, prediction coefficients are optimized for each image, and encoding is performed using the optimized prediction coefficients. In the encoding methods disclosed in Japanese Examined Patent Application Publication No. H07-046868, Japanese Patent No. 3543339, and Japanese Unexamined Patent Application Publication No. H08-084336, a frame or a pixel is predicted from a different frame or a pixel in a different frame, prediction coefficients are determined via learning such that predicted errors are minimized, and encoding is performed using the optimized prediction coefficients.

### SUMMARY OF THE INVENTION

However, in the encoding method disclosed in Japanese Unexamined Patent Application Publication No. 2000-092328 or Japanese Unexamined Patent Application Publication No. 2000-299866, prediction coefficients are set in advance to fixed values, and thus there is a possibility that a great predicted residual occurs depending on a given image even if pixels used in prediction are properly selected, and thus there is a possibility that the encoded data becomes great in data size.

On the other hand, in the encoding method disclosed in Japanese Examined Patent Application Publication No. H07-046868, Japanese Patent No. 3543339, or Japanese Unexamined Patent Application Publication No. H08-084336, it is needed to transmit the prediction coefficients determined via the learning to a decoding apparatus, which results in an increase in the amount of information transmitted to the decoding apparatus. In the encoding method disclosed in Japanese Patent No. 3543339, predicted residuals are encoding using Huffman code or the like. However, the distribution of predicted residuals varies depending on given images, and thus there is a possibility that the amount of information becomes large depending on given images.

In the lossless encoding methods, small residuals such as ±1 are treated as white noise, and there is no known technique that allows it to reduce white noise while achieving high encoding efficiency.

In view of the above, the present invention provides a technique to encode data in a highly efficient form with a small data size and a technique to decode such data.

According to an embodiment of the present invention, there is provided an encoding apparatus configured to encode input image data including a plurality of frames, including prediction coefficient generation means for generating a prediction coefficient for use in prediction of a second frame from a first frame, image prediction means for generating a predicted image from a third frame by using the prediction coefficient, residual generation means for determining a residual component between a current frame to be encoded and the predicted image, and output means for outputting the residual component in the form of encoded data, wherein the first to third frames are frames which occurred, before the occurrence of the current frame, as frames to be encoded.

The second frame and the third frame may be the same frame.

The encoding apparatus may further include motion vector detection means for detecting a motion vector from the first frame and the second frame, motion vector code assigning means for gathering motion vectors detected by the motion vector detection means and assigning codes to the motion vectors, and motion vector encoding means for detecting a motion vector of the current frame with respect to the third fame and encodes the detected motion vector according to the code assignment determined by the motion vector code assigning means, wherein the output means may output, in addition to the encoded data of the residual component, the motion vector encoded by the motion vector encoding means.

In the encoding apparatus, the prediction coefficient generation means may include extraction means for extracting pixels from the first frame and the second frame, detection means for detecting a class from the pixels extracted by the extraction means, and normal equation generation means for generating a normal equation associated with the pixels extracted by the extraction means for each class detected by the detection means, whereby the prediction coefficient may be generated by solving the normal equation.

In the encoding apparatus, the image prediction means may include extraction means for extracting pixels from the first frame and the second frame, whereby the image prediction means may generate the predicted image from the pixels extracted by the extraction means by using the prediction coefficient.

The encoding apparatus may further include extraction means for extracting pixels from the first frame and the second frame, detection means for detecting a class from the pixels extracted by the extraction means, storage means for calculating the residual between the predicted image and the second frame and storing a residual distribution determined for each class detected by the detection means, and residual code assigning means for assigning codes to the residuals of respective classes according to the residual distributions of respective classes stored in the storage means.

In the encoding apparatus, the output means may convert the residual component into encoded data according to the code assignment determined by the residual code assigning means.

In the encoding apparatus, each of the first frame and the third frame may be image data of one or a plurality of frames.

In the encoding apparatus, the prediction coefficient generation means may generate prediction coefficients by generating a linear equation from the first frame and the second frame and determining the coefficients that satisfy the generated linear equation.

According to an embodiment of the present invention, there is provided an encoding method/program, in an encoding apparatus, of encoding input image data including a plurality of frames, including generating a prediction coefficient for use in prediction of a second frame from a first frame, generating a predicted image from a third frame by using the prediction coefficient, determining a residual component between a current frame to be encoded and the predicted image, and converting the residual component into encoded data, wherein the first to third frames are frames which occurred, before the occurrence of the current frame, as frames to be encoded.

According to an embodiment of the present invention, there is provided a decoding apparatus configured to decode input image data including a plurality of frames, including prediction coefficient generation means for generating a prediction coefficient for use in prediction of a second frame from a first frame, image prediction means for generating a predicted image from a third frame by using the prediction coefficient, residual decoding means for decoding an encoded residual component between a current frame to be decoded and the predicted image, and output means for adding the decoded residual component to the predicted image and outputting the result, wherein the first to third frames are frames which were decoded temporally before the current frame.

In the decoding apparatus, the second frame and the third frame may be the same frame.

The decoding apparatus may further include motion vector detection means for detecting a motion vector from the first frame and the second frame, motion vector code assigning means for gathering motion vectors detected by the motion vector detection means and assigning codes to the motion vectors, and motion vector decoding means for decoding encoded motion vector data according to the code assignment determined by the motion vector code assigning means.

In the decoding apparatus, the prediction coefficient generation means may include extraction means for extracting pixels from the first frame and the second frame, detection means for detecting a class from the pixels extracted by the extraction means, and normal equation generation means for generating a normal equation associated with the pixels extracted by the extraction means for each class detected by the detection means, whereby the prediction coefficient may be generated by solving the normal equation.

In the decoding apparatus, the image prediction means may include extraction means for extracting pixels from the first frame and the second frame, whereby the image prediction means may generate the predicted image from the pixels extracted by the extraction means by using the prediction coefficient.

The decoding apparatus may further include extraction means for extracting pixels from the first frame and the second frame, detection means for detecting a class from the pixels extracted by the extraction means, storage means for calculating the residual between the predicted image and the second frame and storing a residual distribution determined for each class detected by the detection means, and residual code assigning means for assigning codes to the residuals of respective classes according to the residual distributions of respective classes stored in the storage means, wherein residual decoding means may decode the encoded residual component according to the codes assigned by the residual code assigning means.

In the decoding apparatus, each of the first frame and the third frame may be image data of one or a plurality of frames.

In the decoding apparatus, the prediction coefficient generation means may generate prediction coefficients by generating a linear equation from the first frame and the second frame and determining the coefficients that satisfy the generated linear equation.

According to an embodiment of the present invention, there is provided a decoding method/program, in a decoding apparatus, of decoding input image data including a plurality of frames, including generating a prediction coefficient for use in prediction of a second frame from a first frame, generating a predicted image from a third frame by using the prediction coefficient, decoding an encoded residual component between a current frame to be decoded and the predicted image, and adding the decoded residual component to the predicted image, wherein the first to third frames are frames which were decoded temporally before the current frame.

According to an embodiment of the present invention, there is provided a storage medium in which the program is stored.

In the method, apparatus, and program for encoding, as described above, prediction coefficients are determined from past frames, a predicted image is produced from a particular frame by using the prediction coefficients, a residual between the predicted image and a current frame to be encoded is calculated, and the residual is supplied to a decoding apparatus.

In the method, apparatus, and program for decoding, as described above, prediction coefficients are calculated from past frames which have already been decoded, a predicted image is produced from a particular frame by using the prediction coefficients, the encoded residual is decoded, and the decoded residual is added to the predicted image.

The preset invention provides an advantage that encoding is performed losslessly.

Another advantage is that data can be encoded into a form with a small data size, and thus the amount of data transmitted to a decoding apparatus becomes small.

### BRIEF DESCRIPTION OF THE DRAWINGS

FIG. 1 is a block diagram showing a configuration of an encoding apparatus according to a first embodiment of the present invention;

FIG. 2 is a block diagram showing functional blocks of an encoding apparatus;

FIG. 3 is a diagram showing a manner in which a frame is divided into a plurality of blocks;

FIG. 4A shows a block of interest and FIG. 4B shows a search area;

FIG. 5 is a diagram showing a manner in which a motion vector is detected;

FIGS. 6A and 6B are diagrams showing taps;

FIG. 7 shows examples of residual distributions;

FIG. 8 is a diagram showing initial values of motion vectors;

FIG. 9 is a diagram showing initial values of motion vectors;

FIG. 10 is a diagram showing an initial state associated with normal equations;

FIG. 11 is a diagram showing an initial state associated with normal equations;

FIG. 12 is a diagram showing an initial state associated with residual distributions;

FIG. 13 is a diagram showing an initial state associated with residual distributions;

FIG. 14 is a block diagram showing an example of a configuration of a personal computer;

FIG. 15 is a flow chart showing an operation of an encoding apparatus;

FIG. 16 is a flow chart showing a learning process;

FIG. 17 is a flow chart showing a prediction process;

FIG. 18 is a flow chart showing an encoding process;

FIG. 19 is a block diagram showing an example of a configuration of a decoding apparatus;

FIG. 20 is a block diagram showing functional blocks of a decoding apparatus;

FIG. 21 is a flow chart showing an operation of a decoding apparatus;

FIG. 22 is a flow chart showing a learning process;

FIG. 23 is a flow chart showing a prediction process;

FIG. 24 is a flow chart showing a decoding process;

FIG. 25 is a flow chart showing a configuration of an encoding apparatus according to an embodiment of the present invention;

FIG. 26 is a diagram showing an encoding process according to an embodiment of the present invention;

FIG. 27 is a flow chart showing an encoding process;

FIG. 28 shows an example of a configuration of a decoding apparatus; and

FIG. 29 is a flow chart showing a decoding process.

### DESCRIPTION OF THE PREFERRED EMBODIMENTS

Before embodiments of the present invention are described, correspondence between specific examples of parts/steps in the embodiments and those in the respective claims is described. This description is intended to assure that embodiment supporting the claimed invention are described in this specification or the drawings. Thus, even if an element in the following embodiments is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

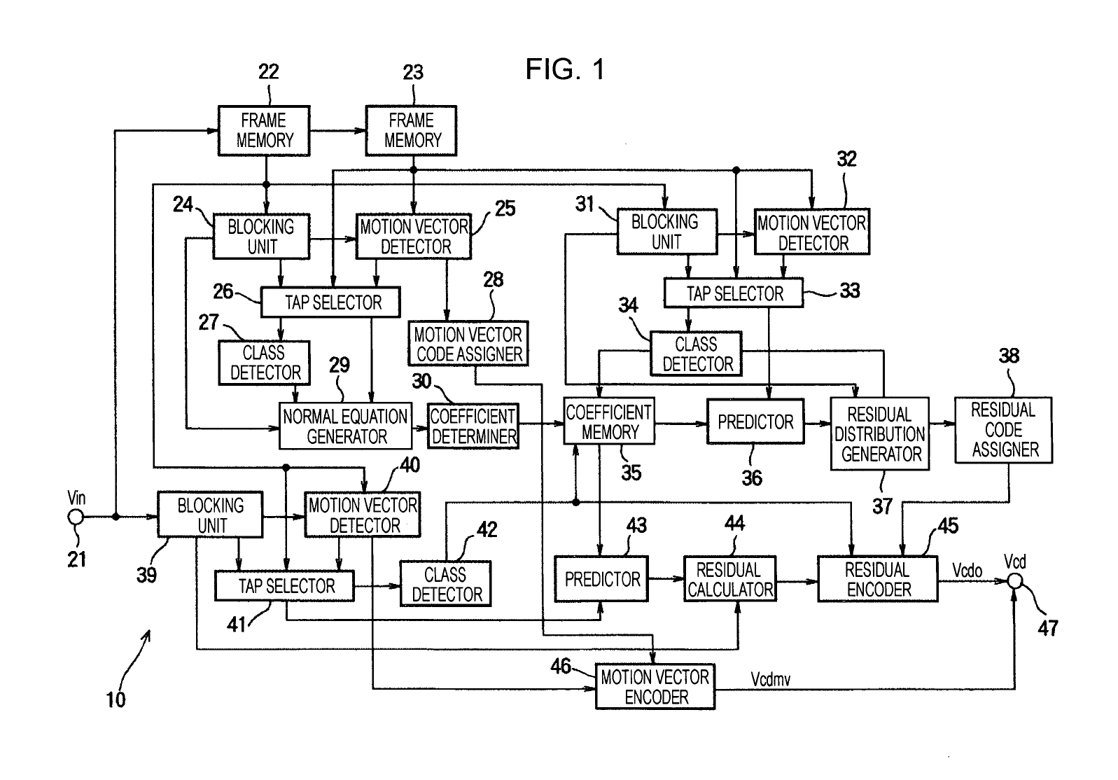

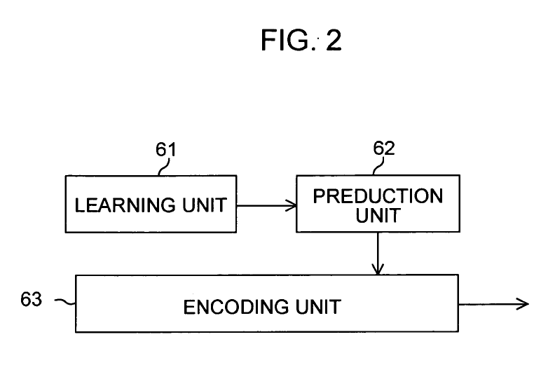

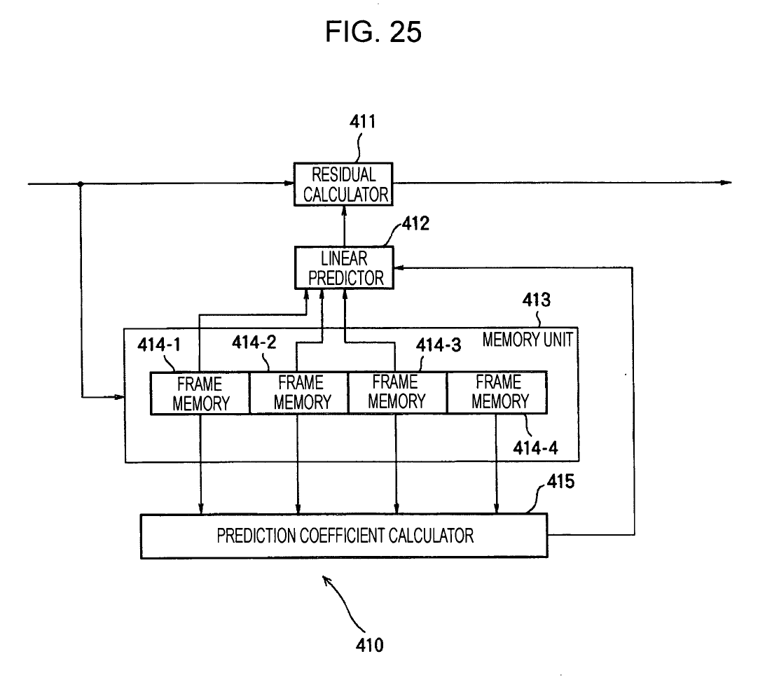

According to an embodiment of the present invention, there is provided an encoding apparatus (for example, an encoding apparatus 10 shown in FIG. 1 or an encoding apparatus 410 shown in FIG. 25) including prediction coefficient generation means (for example, a learning unit 61 shown in FIG. 2 or a prediction coefficient calculator 415 shown in FIG. 25) for generating a prediction coefficient for use in prediction of a second frame from a first frame, image prediction means (for example, a prediction unit 62 shown in FIG. 2 or a linear predictor 412 shown in FIG. 25) for generating a predicted image from a third frame by using the prediction coefficient, residual generation means (for example, an encoding unit 63 shown in FIG. 2 or a residual calculator 411 shown in FIG. 25) for determining a residual component between a current frame to be encoded and the predicted image, and output means (for example, an encoding unit 63 shown in FIG. 2 or a residual calculator 411 shown in FIG. 25) for outputting the residual component in the form of encoded data.

The encoding apparatus may further include motion vector detection means (for example, a motion vector detector 25 shown in FIG. 1) for detecting a motion vector from the first frame and the second frame, motion vector code assigning means for example, a motion vector code assigner 28 shown in FIG. 1) for gathering motion vectors detected by the motion vector detection means and assigning codes to the motion vectors, and motion vector encoding means (for example, a motion vector encoder 46 shown in FIG. 1) for detecting a motion vector of the current frame with respect to the third fame and encodes the detected motion vector according to the code assignment determined by the motion vector code assigning means.

In the encoding apparatus, the prediction coefficient generation means may include extraction means (for example, a tap selector 26 shown in FIG. 1) for extracting pixels from the first frame and the second frame, detection means (for example, a class detector 27 shown in FIG. 1) for detecting a class from the pixels extracted by the extraction means, and normal equation generation means (for example, a normal equation generator 29 shown in FIG. 1) for generating a normal equation associated with the pixels extracted by the extraction means for each class detected by the detection means.

In the encoding apparatus, the image prediction means may include extraction means (for example, a tap selector 33 shown in FIG. 1) for extracting pixels from the first frame and the second frame.

The encoding apparatus may further include extraction means (for example, a tap selector 33 shown in FIG. 1) for extracting pixels from the first frame and the second frame, detection means (for example, a class detector 34 shown in FIG. 1) for detecting a class from the pixels extracted by the extraction means, storage means (for example, a residual distribution generator 37 shown in FIG. 1) for calculating the residual between the predicted image and the second frame and storing a residual distribution determined for each class detected by the detection means, and residual code assigning means (for example, a residual code assigner 39 shown in FIG. 1) for assigning codes to the residuals of respective classes according to the residual distributions of respective classes stored in the storage means.

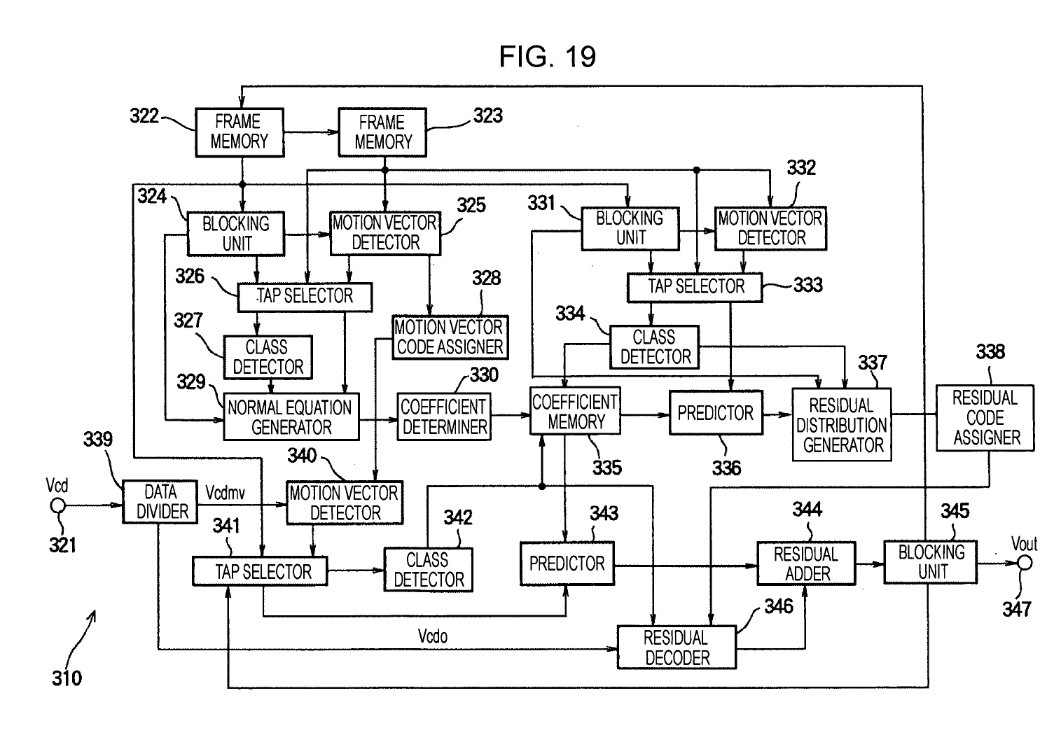

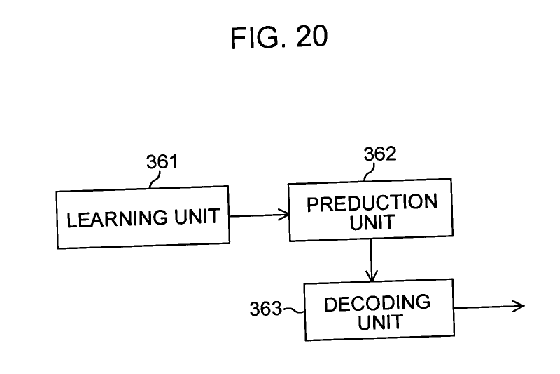

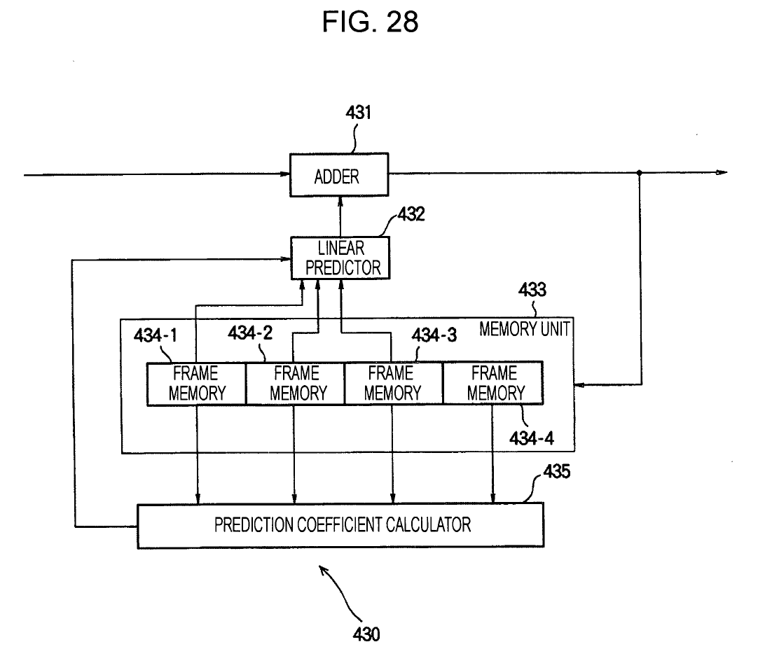

According to an embodiment of the present invention, there is provided a decoding apparatus (for example, a decoding apparatus 310 shown in FIG. 19 or a decoding apparatus 430 shown in FIG. 28) including prediction coefficient generation means (for example, a learning unit 361 shown in FIG. 20 or a prediction coefficient calculator 435 shown in FIG. 28) for generating a prediction coefficient for use in prediction of a second frame from a first frame, image prediction means (for example, a prediction unit 362 shown in FIG. 20 or a linear predictor 432 shown in FIG. 28) for generating a predicted image from a third frame by using the prediction coefficient, residual decoding means (for example, a decoding unit 363 shown in FIG. 20 or an adder 431 shown in FIG. 28) for decoding an encoded residual component between a current frame to be decoded and the predicted image, and output means (for example, a decoding unit 363 shown in FIG. 20 or an adder 431 shown in FIG. 28) for adding the decoded residual component to the predicted image and outputting the result.

The decoding apparatus may further include motion vector detection means (for example, a motion vector detector 325 shown in FIG. 19) for detecting a motion vector from the first frame and the second frame, motion vector code assigning means (for example, a motion vector code assigner 328 shown in FIG. 19) for gathering motion vectors detected by the motion vector detection means and assigning codes to the motion vectors, and motion vector decoding means (for example, a motion vector decoder 340 shown in FIG. 19) for decoding encoded motion vector data according to the code assignment determined by the motion vector code assigning means.

In the decoding apparatus, the prediction coefficient generation means may include extraction means (for example, a tap selector 326 shown in FIG. 19) for extracting pixels from the first frame and the second frame, detection means (for example, a class detector 327 shown in FIG. 19) for detecting a class from the pixels extracted by the extraction means, and normal equation generation means (for example, a normal equation generator 329 shown in FIG. 19) for generating a normal equation associated with the pixels extracted by the extraction means for each class detected by the detection means.

In the decoding apparatus, the image prediction means may include extraction means (for example, a tap selector 333 shown in FIG. 19) for extracting pixels from the first frame and the second frame.

The decoding apparatus may further include extraction means (for example, a tap selector 333 shown in FIG. 19) for extracting pixels from the first frame and the second frame, detection means (for example, a class detector 334 shown in FIG. 19) for detecting a class from the pixels extracted by the extraction means, storage means (for example, a residual distribution generator 337 shown in FIG. 19) for calculating the residual between the predicted image and the second frame and storing a residual distribution determined for each class detected by the detection means, and residual code assigning means (for example, a residual code assigner 339 shown in FIG. 19) for assigning codes to the residuals of respective classes according to the residual distributions of respective classes stored in the storage means.

The present invention is described in further detail below with reference to embodiments in conjunction with the accompanying drawings.

First Embodiment

In the following description, an encoding apparatus is first explained, and then a decoding apparatus for decoding data encoded by the encoding apparatus is explained.

Configuration of Encoding Apparatus

FIG. 1 is a block diagram showing a configuration of the decoding apparatus according to an embodiment of the present invention. As shown in FIG. 1, the encoding apparatus 10 includes an input terminal 21, a frame memory 22, a frame memory 23, a blocking unit 24, a motion vector detector 25, a tap selector 26, a class detector 27, a motion vector code assigner 28, a normal equation generator 29, a coefficient determiner 30, a blocking unit 31, a motion vector detector 32, a tap selector 33, a class detector 34, a coefficient memory 35, a predictor 36, a residual distribution generator 37, a residual code assigner 38, a blocking unit 39, a motion vector detector 40, a tap selector 41, a class detector 42, a predictor 43, a residual calculator 44, a residual encoder 45, a motion vector encoder 46, and an output terminal 47.

Before the operations of units in the encoding apparatus 10 and data generated by these units are described, a data flow in the encoding apparatus 10 is described first.

Data input via the input terminal 21 is supplied to the frame memory 22 and the blocking unit 39. Data output from the frame memory 22 is supplied to the frame memory 23, the blocking unit 24, the blocking unit 31, the motion vector detector 40, and the tap selector 41. Data output from the frame memory 23 is supplied to the motion vector detector 25, the tap selector 26, the motion vector detector 32, and the tap selector 33.

Data output from the blocking unit 24 is supplied to the motion vector detector 25, the tap selector 26, and the normal equation generator 29. Data output from the motion vector detector 25 is supplied to the tap selector 26 and the motion vector code assigner 28. Data output from the tap selector 26 is supplied to the class detector 27 and the normal equation generator 29. Data output from the class detector 27 is supplied to the normal equation generator 29.

Data output from the motion vector code assigner 28 is supplied to the motion vector encoder 46. The data output from normal equation generator 29 is supplied to the coefficient determiner 30. Data output from the coefficient determiner 30 is supplied to the coefficient memory 35.

Data output from the blocking unit 31 is supplied to the motion vector detector 32, the tap selector 33, and the residual distribution generator 37. Data output from motion vector detector 32 is supplied to the tap selector 33. Data output from the tap selector 33 is supplied to the class detector 34 and the predictor 36. Data output from the class detector 34 is supplied to the coefficient memory 35 and the residual distribution generator 37.

Data output from the coefficient memory 35 is supplied to the predictor 36 and the predictor 43. Data output from the predictor 36 is supplied to the residual distribution generator 37. Data output from the residual code assigner 38 is supplied to the residual encoder 45.

Data output from the blocking unit 39 is supplied to the motion vector detector 40, the tap selector 41, and the residual calculator 44. Data output from the motion vector detector 40 is supplied to the tap selector 41 and the motion vector encoder 46. Data output from the tap selector 41 is supplied to the class detector 42 and the predictor 43. Data output from class detector 42 is supplied to the coefficient memory 35 and the residual encoder 45.

Data output from the predictor 43 is supplied to the residual calculator 44. Data output from the residual calculator 44 is supplied to the residual encoder 45. Data output from the residual encoder 45 is supplied the output terminal 47. Data output from the motion vector encoder 46 is supplied to the output terminal 47.

In the encoding apparatus 10 shown in FIG. 1, data is transferred in the above-described manner.

The encoding apparatus 10, which is constructed in the above-described manner and in which data is transferred in the above-described manner, can be roughly divided in three main units: a learning unit 61, a prediction unit 62, and an encoding unit 63, as shown in FIG. 2. The learning unit 61 includes the blocking unit 24, the motion vector detector 25, the tap selector 26, the class detector 27, the motion vector code assigner 28, the normal equation generator 29, and the coefficient determiner 30. That is, block units located in an upper left area of the block diagram shown in FIG. 1 are main components of the learning unit 61.

The prediction unit 62 includes the blocking unit 31, the motion vector detector 32, the tap selector 33, the class detector 34, the coefficient memory 35, the predictor 36, the residual distribution generator 37, and the residual code assigner 38. That is, block units located in an upper right area of the block diagram shown in FIG. 1 are main parts of the prediction unit 62.

The encoding unit 63 includes the blocking unit 39, the motion vector detector 40, the tap selector 41, the class detector 42, the predictor 43, the residual calculator 44, the residual encoder 45, and the motion vector encoder 46. That is, block units located in a lower area of the block diagram shown in FIG. 1 are main parts of the encoding unit 63.

The encoding apparatus 10 shown in FIG. 1 and FIG. 2 performs prediction depending on characteristics of a given image, assigns codes depending on a residual distribution that occurs as a result of the prediction, and encodes the residual, as will be described in detail below. To this end, the learning unit 61 performs learning and calculates prediction coefficients, and the prediction unit 62 assigns codes to the residuals according to the residual distribution that occurs as the result of the prediction performed using the calculated prediction coefficients.

A frame of interest (which is being input via the input terminal 21 and which is to be subjected to the encoding process) is processed such that a prediction process is performed by the prediction unit 62 according to already calculated prediction coefficients, and a residual is encoded in accordance with already determined code assignment thereby making it possible for a decoding apparatus to decode the frame without receiving information about the prediction coefficients and code assignment from the encoding apparatus.

The operation of each unit in the encoding apparatus 10 shown in FIG. 1, performed in the encoding process, is described below.

Each of the frame memory 22 and the frame memory 23 stores supplied motion image data in units of frames. In the configuration shown in FIG. 1, the image data stored in the frame memory 22 is image data of a frame immediately before a current frame being input to the input terminal 21, and the image data stored in the frame memory 23 is image data of a frame immediately before the frame stored in the frame memory 22 (that is, two frames before the frame being input to the input terminal 21).

Hereinafter, the frame which is input to the input terminal 21 and which is to be subjected to the encoding process is denoted as a frame N, the frame stored in the frame memory 22 is denoted as a frame N−1, and the frame stored in the frame memory 23 is denoted as a frame N−2. The current frame which is being input to the input terminal 21 and which is to be subjected to the encoding process will also be referred to as a frame of interest (or as a frame N of interest).

The blocking unit 24 divides the frame stored in the frame memory 22 into a plurality of blocks with a predetermined size. Note that herein and hereinafter the term “frame” is used not only to describe a frame but also image data of a frame. Similarly, the blocking unit 31 divides the frame stored in the frame memory 23 into a plurality of blocks with a predetermined size, and the blocking unit 39 divides the frame N input via the input terminal 21 into a plurality of blocks with a predetermined size. Thus, three successive frames are processed by the respective blocking units 24, 31, and 39.

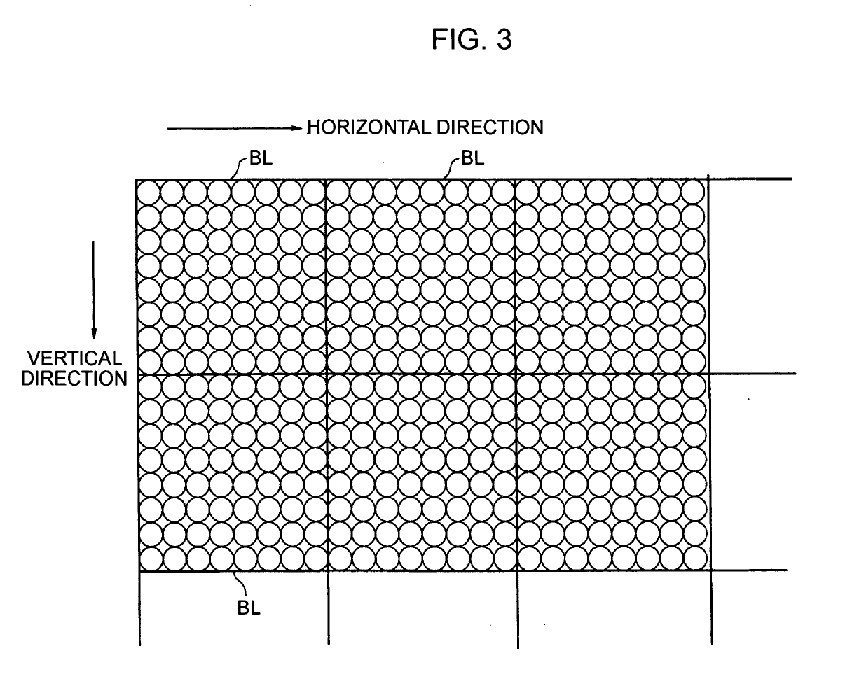

The blocking process performed by the blocking unit 24 is described below with reference to FIG. 3. One frame of image data (representing an image of an effective screen) stored in the frame memory 22 is supplied to the blocking unit 24. FIG. 3 shows a part of the supplied frame N−1. In FIG. 3, open circles represent pixels forming a block. Each frame is divided into a plurality of blocks (in FIG. 3, each square unit area surrounded by lines represents one block) each including a total of 64 pixels arranged in the form of an array including eight horizontal rows and eight vertical columns.

Although in the present embodiment, one block is assumed to include a total of 64 pixels in the form of an 8×8 array, there is no restriction on the number of pixels. The blocks produced by the blocking unit 24 are supplied to the motion vector detector 25.

In addition to the frame N−1 divided into blocks by the blocking unit 24, the frame N−2 stored in the frame memory 23 is also supplied to the motion vector detector 25. The motion vector detector 25 detects motion vectors of respective blocks of the frame N−1 supplied from the blocking unit 24 with respect to the frame N−2 stored in the frame memory 23.

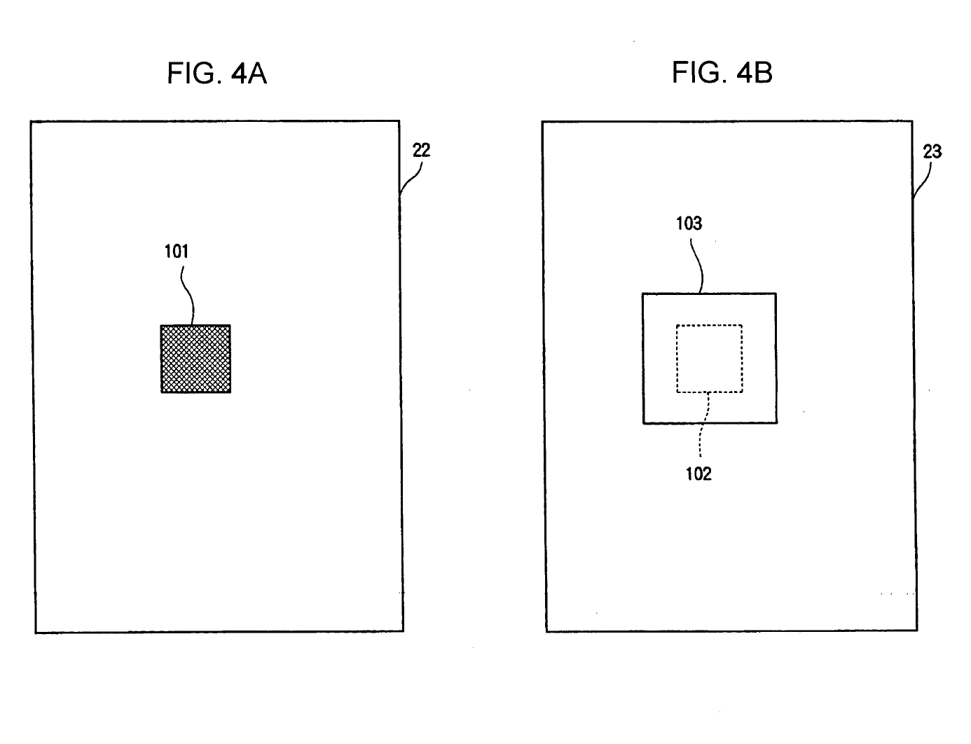

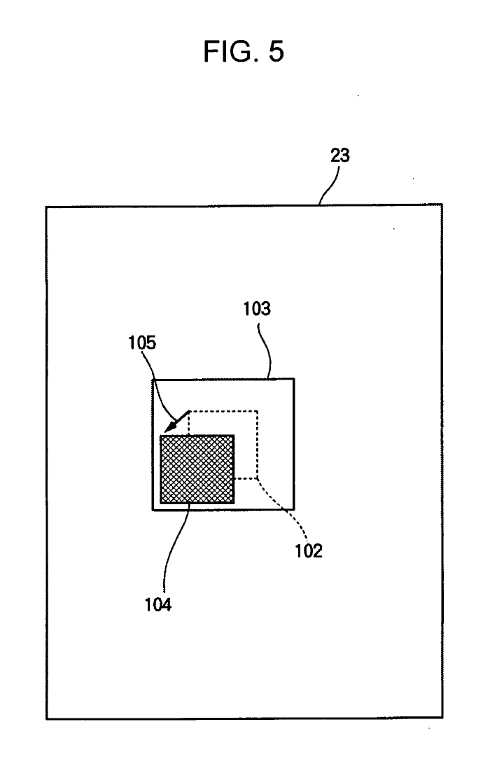

With reference to FIG. 4A, FIG. 4B, and FIG. 5, the motion vectors detected by the motion vector detector 25 are described below. As shown in FIG. 4A, one block including 64 blocks is selected as a block of interest 101 from the blocks into which the frame N−1 stored in the frame memory 22 has been divided by the blocking unit 24. Meanwhile, as shown in FIG. 4B, the frame N−2 stored in the frame memory 23 is searched to find an area 102 including 64 pixels and located at a position corresponding to the position of the block of interest 101 in the frame N−1.

Furthermore, an area with a predetermined size greater than the size of the area 102 is set as a search area 103. The size of the search area 103 is set, for example, so as to be horizontally greater by 8 pixels from the left side and 8 pixels from the right side of the area 102 and vertically greater by 8 pixels from the upper side and from the lower side of the area 102.

In the above process, the motion vector detector 25 determines the area 102 by detects the position, in the frame N−2 stored in the frame memory 23, which corresponds to the position of the block 101 of interest supplied from the blocking unit 24, and the motion vector detector 25 further selects the search area 103 according to the determined area 102. The motion vector detector 25 then searches the search area 103 to find a block (area) having a minimum value in the sum of absolute values of differences between pixel values in the block 101 of interest and pixel values in this block (area).

Referring to FIG. 5, let a block 104 be a detected block (area) having a minimum value in the sum of the absolute values of difference in pixel values between the block 101 of interest and the block 104. The motion vector detector 25 calculates the relative coordinates of the detected block 104 with respect to the coordinates of the area 102 corresponding to the position of the block 101 of interest in the frame, and the motion vector detector 25 employs the calculated relative coordinates as the motion vector.

As described above, the motion vector is detected by detecting, from the frame N−2, a block similar to a block in the frame N−1. The motion vector detected by the motion vector detector 25 is supplied to the tap selector 26 and the motion vector code assigner 28.

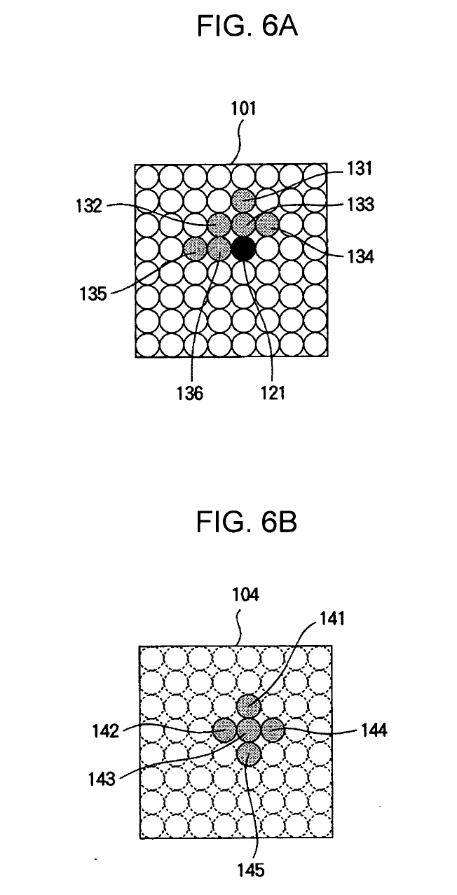

In addition to the motion vector detected by the motion vector detector 25, the tap selector 26 also receives the frame N−2 from the frame memory 23 and blocks from the blocking unit 24. The tap selector 26 selects particular pixels (pixel data of pixels) as described below with reference to FIGS. 6A and 6B.

FIG. 6A shows an example of a manner in which the tap selector 26 selects particular pixels from the block 101 of interest. In the example shown in FIG. 6A, when a pixel 121 is given as a pixel of interest, six pixels 131 to 136 are extracted from the block 101 of interest.

In the example shown in FIG. 6A, two pixels 131 and 134 at vertically upper locations with respect to the location of the pixel 121 of interest, one pixel 132 at an upper left location, one pixel 134 at an upper right location, and two pixels 135 and 136 to the left of the pixel 121 of interest are selected from the block 101 of interest area. Note that when pixels are raster-scanned, these selected pixels 131 to 136 are scanned before the pixel 121 of interest.

Similarly, pixels are also selected from the detected block 104. The tap selector 26 detects a block corresponding to the block 101 of interest in the frame N−2 on the basis of the frame N−2 supplied from the frame memory 23 and the motion vector supplied from the motion vector detector 25. Thus, the detected block 104 is obtained.

The tap selector 26 also selects five pixels 141 to 145 in the detected block 104. More specifically, as shown in FIG. 6B, a pixel 143 of interest corresponding to the pixel 121 of interest, pixels 141 and 145 respectively located at upper and lower adjacent positions with respect to the position of the pixel 143 of interest, and pixels 142 and 144 respectively located at adjacent positions to the left and right of the pixel 143 of interest.

The tap selector 26 selects particular pixels (that is, selects taps) from the blocks 101 of interest and block 104 of interest in the above described manner. The pixel data of pixels extracted by the tap selector 26 is supplied to the class detector 27 and the normal equation generator 29.

The class detector 27 creates a class for the pixel data extracted by the tap selector 26 (that is, the class detector 27 classifies the pixel data) in accordance with the feature value of the pixels. More specifically, the class detector 27 creates the class for the pixel data by performing ADRC (Adaptive Dynamic Range Coding) on the extracted pixel data.

In the ADRC process, the requantized code. Qᵢ for pixel data Kᵢ is calculated according to equation (1)
Qᵢ=[(Kᵢ−MIN+0.5)×2P/DR] (1)
where DR=MAX−MIN+1 denotes the dynamic range of the pixel data, MAX denotes the maximum value of the pixel data, MIN denotes the minimum value of the pixel data, P denotes the number of bits of the requantized code, and [ ] denotes a round-down function.

A class code CL is then calculated from the requantized code Qi obtained for each pixel data of the extracted pixels (in this specific case, a total of eleven pixels 131 to 136 and 141 to 145) supplied from the tap selector 26 by performing a calculation according to equation (2).

$$CL = {\sum }_{i = 1}^{Na} {{Q}_{i} ( {2}^{P} )}^{i} \qquad ( 2 )$$

In equation (2), i takes values from 1 to Na when there are as many image data as Na. The normal equation generator 29 generates a normal equation by means of learning from the block 101 of interest supplied from the blocking unit 24, pixel data of the pixels extracted by the tap selector 26, and the class determined by the class detector 27. More specifically, the normal equation generator 29 generates data from which to determine coefficient values that allow the sum of square errors to be minimized for each class, from the pixel data of a student signal (in the present example, pixels supplied from the tap selector 26) and the pixel data of a teacher signal (in the present example, pixels in the block 101 of interest supplied from the blocking unit 24).

When the number of training data is m and the residual of k-th training data is eₖ, the sum E of square errors can be given by equation (3).

$$\begin{matrix}E = {\sum }_{k = 1}^{m} {e}_{k}^{2} \\ = {\sum }_{k = 1}^{m} {[ {y}_{k} - ( {w}_{1} {x}_{1 k} + {w}_{2} {x}_{2 k} + … + {w}_{n} {x}_{nk} ) ]}^{2}\end{matrix} \qquad ( 3 )$$

where xᵢₖ is k-th pixel data at an i-th prediction tap position of pixels (student signal) extracted by the tap selector 26, yₖ is k-th pixel data of the pixel of interest (teacher signal) corresponding to xᵢₖ, and wᵢ is a prediction coefficient at an i-th pixel (prediction tap). In the solution process using the least square method, the prediction coefficients wᵢ are determined at which the partial differential of equation (3) with respect to prediction coefficients wi equal 0. Such values of the

$$\frac{\partial E}{\partial {w}_{i}} = {\sum }_{k = 1}^{m} 2 ( \frac{\partial {e}_{k}}{\partial {w}_{i}} ) {e}_{k} = - {\sum }_{k = 1}^{m} 2 {x}_{ik} {e}_{k} = 0 \qquad ( 4 )$$

prediction coefficients can be determined by equation (4).

If Xᵢⱼ and Yᵢ are respectively defined by equations (5) and (6), then equation (4) can be rewritten as equation (7) using a matrix.

$$\begin{matrix}{X}_{ij} = {\sum }_{k = 1}^{m} {x}_{ik} {x}_{jk} & ( 5 ) \\ {Y}_{i} = {\sum }_{k = 1}^{m} {x}_{ik} {y}_{j} & ( 6 ) \\ [ \begin{matrix}{X}_{11} & {X}_{12} & ⋯ & {X}_{1 n} \\ {X}_{21} & {X}_{22} & ⋯ & {X}_{2 n} \\ ⋮ & ⋮ & ⋰ & ⋮ \\ {X}_{n 1} & {X}_{n 2} & ⋯ & {X}_{nm}\end{matrix} ] [ \begin{matrix}{w}_{10} \\ {w}_{11} \\ ⋮ \\ {w}_{n}\end{matrix} ] = [ \begin{matrix}{Y}_{1} \\ {Y}_{2} \\ ⋮ \\ {Y}_{n}\end{matrix} ] & ( 7 )\end{matrix}$$

Equation (7) is referred to as a normal equation. The normal equation generator 29 generates such a normal equation for each class.

The coefficient determiner 30 solves the normal equation generated by the normal equation generator 29 by using a sweeping out method (also called a Gauss-Jordan elimination method) or the like with respect to prediction coefficients wi thereby determining the coefficient data. The coefficient memory 35 stores the coefficient data determined by the coefficient determiner 30 for each class.

The motion vector code assigner 28 stores all motion vectors detected by the motion vector detector 25 for all blocks given by the blocking unit 24. The motion vector code assigner 28 then assigns a code to each motion vector according to a motion vector distribution, for example, using a Huffman code.

The learning is performed by respective units in the learning unit 61 as described above. That is, as a result of the learning, assigning of codes to the motion vector is performed (described later in detail) and the coefficient data is stored in the coefficient memory 35 for each class.

Now, the operation of each unit in the prediction unit 62 is described below.

The blocking unit 31 performs a process similar to the process performed by the blocking unit 24. More specifically, the blocking unit 31 divides the frame N−1 stored in the frame memory 22 into a plurality of block each including 64 pixels (that is, the blocking unit 31 divides the frame N−1 processed by the blocking unit 24 in the same manner as the manner in which the blocking unit 24 divides the frame N−1). Data output from the blocking unit 31 is supplied to the motion vector detector 32 and the tap selector 33.

The motion vector detector 32 performs a process similar to that performed by the motion vector detector 25 to detect motion vectors for blocks defined by the blocking unit 31 relative to the frame stored in the frame memory 23. The motion vector detected by the motion vector detector 32 is supplied to the tap selector 33.

The tap selector 33 performs a process similar to that performed by the tap selector 26 to extract particular pixels (pixel data) from the block of interest supplied from the blocking unit 31 and from the frame N−2 stored in the frame memory 23 according to the motion vector detected by the motion vector detector 25. The pixel data of pixels extracted by the tap selector 33 is supplied to the class detector 34 and the predictor 36.

The class detector 34 performs a process similar to that performed by the class detector 27 to create a class (to perform classification). The class created by the class detector 34 is supplied to the coefficient memory 35 and stored therein. The class created by the class detector 34 is also supplied to the residual distribution generator 37.

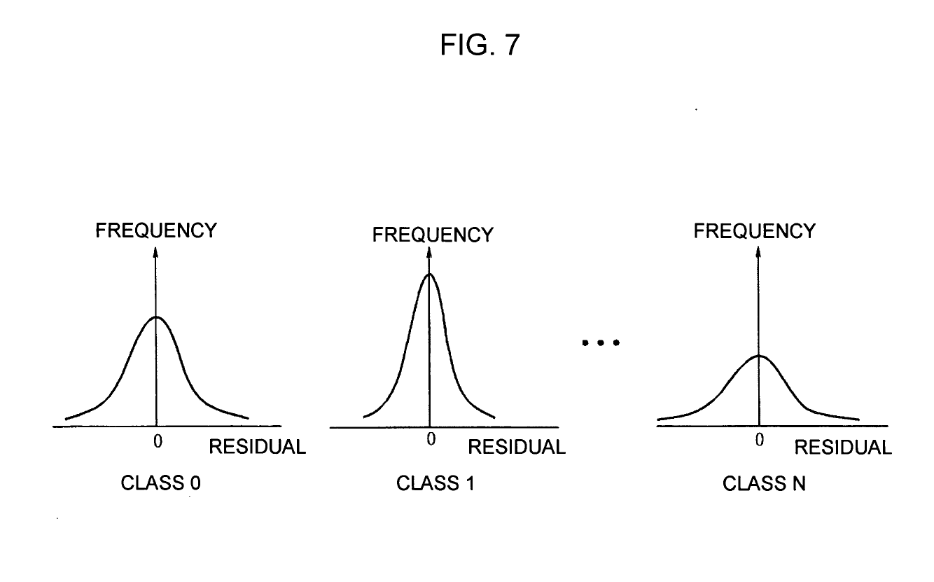

The predictor 36 calculates the predicted value y′ using the coefficient data read from the coefficient memory 35 for the class detected by the class detector 35 and using the pixel data supplied from the tap selector 33, according to equation (8).

$${y}^{′} = {\sum }_{i = 1}^{n} {w}_{i} {x}_{i} \qquad ( 8 )$$

where xᵢ is the pixel data supplied from the tap selector 33 and wᵢ is the coefficient data. The residual distribution generator 37 calculates the residual between the value of each pixel of interest supplied from the blocking unit 31 and the corresponding predicted value supplied from the predictor 36 and stores a distribution of residuals for each class. For example, as shown in FIG. 7, the residual distribution generator 37 produces a graph indicating the residual along a horizontal axis and the frequency of the residual along a vertical axis (that is, the residual distribution is stored for each class).

The residual code assigner 38 assigns codes to residuals for each class according to the residual distribution stored in the residual distribution generator 37, by using, for example, Huffman codes. That is, codes are assigned according to the residual distribution for each class.

The prediction is performed by respective units of the prediction unit 62 as described above. That is, codes are assigned according to the residual distributions of the respective classes.

Now, the operation of each unit in the encoding unit 63 is described below.

The blocking unit 39, as with the blocking unit 24, divides the frame N input via the input terminal 21 into a plurality of blocks each including 64 pixels and supplies the blocks to the motion vector detector 40 and the tap selector 41.

The motion vector detector 40 performs a process similar to that performed by the motion vector detector 25 to detect a motion vector for each block supplied from the blocking unit 39 with respect to the frame N−1 stored in the frame memory 22 and supplies the detected motion vector of each block to the tap selector 41 and motion vector encoder 46.

Note that unlike the motion vector detector 25 and the motion vector detector 32, the motion vector detector 40 detects the motion vector for each block of the current frame input via the input terminal 21 (that is, the frame immediately after the frame N−1 stored in the frame memory 22) with respect to the frame N−1 stored in the frame memory 22.

The tap selector 41 performs a process similar to that performed by the tap selector 26 to extract particular pixels (pixel data) from the block of interest supplied from the blocking unit 39 and from the frame N−1 stored in the frame memory 22 according to the motion vector detected by the motion vector detector 40. The pixel data of pixels extracted by the tap selector 41 is supplied to the class detector 42 and the predictor 43.

The class detector 42 performs a process similar to that performed by the class detector 27 to create a class (to perform classification). The class created by the class detector 34 is supplied to the residual encoder 45. Note that the class detected by the class detector 42 is a class for the frame N of interest. The class detector 42 may be configured in a similar manner to the class detector 27 used in the learning.

The predictor 43 calculates the predicted value y′ using the coefficient data read from the coefficient memory 35 for the class detected by the class detector 42 and using the pixel data supplied from the tap selector 41, according to an equation similar to equation (8). The calculated predicted value y′ is supplied to the residual calculator 44.

The residual calculator 44 calculates the residual difference between the value of the pixel of interest supplied from the blocking unit 39 and the predicted value given by the predictor 43. The residual encoder 45 encodes the residual according to the class detected by the class detector 42 and the code assignment determined by the residual code assigner 38, and outputs the resultant encoded residual as Vcdo. Thus, the residual is first encoded.

The motion vector encoder 46 encodes the motion vector detected by the motion vector detector 40 according to the code assignment determined by the motion vector code assigner 28, and outputs the resultant encoded motion vector as Vcdmv. Thus, the motion vector is encoded.

The encoded data Vcdmv produced by the motion vector encoder 46 and encoded data Vcdo produced by the residual encoder 45 are output as encoded data Vcd via the output terminal 47.

After the processes performed by the various units on the frame N of interest input via the input terminal 21 are completed, a new frame to be processed as a new frame of interest is input via the input terminal 21 and frames stored in the frame memory 22 and the frame memory 23 are updated.

In the frame memory 22 and the frame memory 23, as described above, the frame N−1 and the frame N−2 are respectively stored. However, when a frame is input to the input terminal 21 for the first or second time (that is, when a first or second frame is input to the input terminal 21), no frame exists in the frame memory 22 and the frame memory 23. Therefore, in this state, it is impossible to perform the encoding process using the frames stored in the frame memory 22 and the frame memory 23 in the above-describe manner.

Therefore, the first and second frames given in the state in which no frame exists in the frame memory 22 and the frame memory 23 are encoded differently from the process described above.

In the process performed in the normal state described above, the motion vector code assigner 28, the normal equation 29, and the residual distribution generator 37 operate using data stored therein. In other words, the motion vector code assigner 28, the normal equation 29, and the residual distribution generator 37 cannot correctly operate when there is no sample data.

For example, as described above with reference to FIG. 7, the residual distribution generator 37 has data indicating the residual distribution for each class. However, if there is no sample data, the residual distribution generator 37 cannot obtain distribution data such as that shown in FIG. 7, and thus the residual distribution generator 37 cannot correctly operate.

To avoid the above problem, in the initial state, initial value data is stored in the motion vector code assigner 28, the normal equation generator 29, and the residual distribution generator 37. As for the data stored as the initial value data, data created in advance by means of learning using an arbitrary image may be employed.

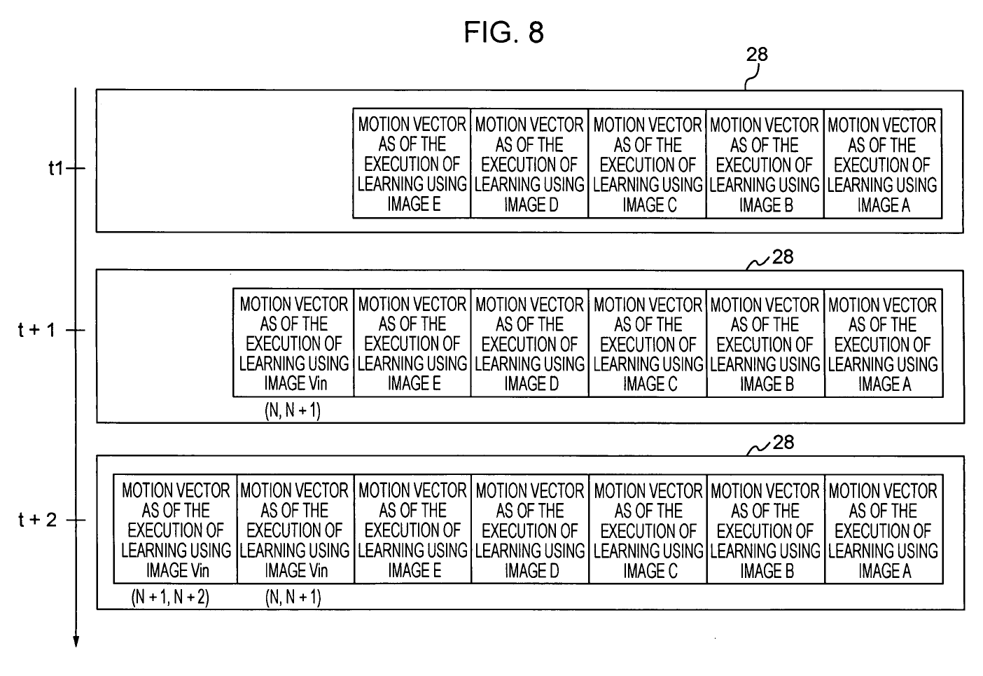

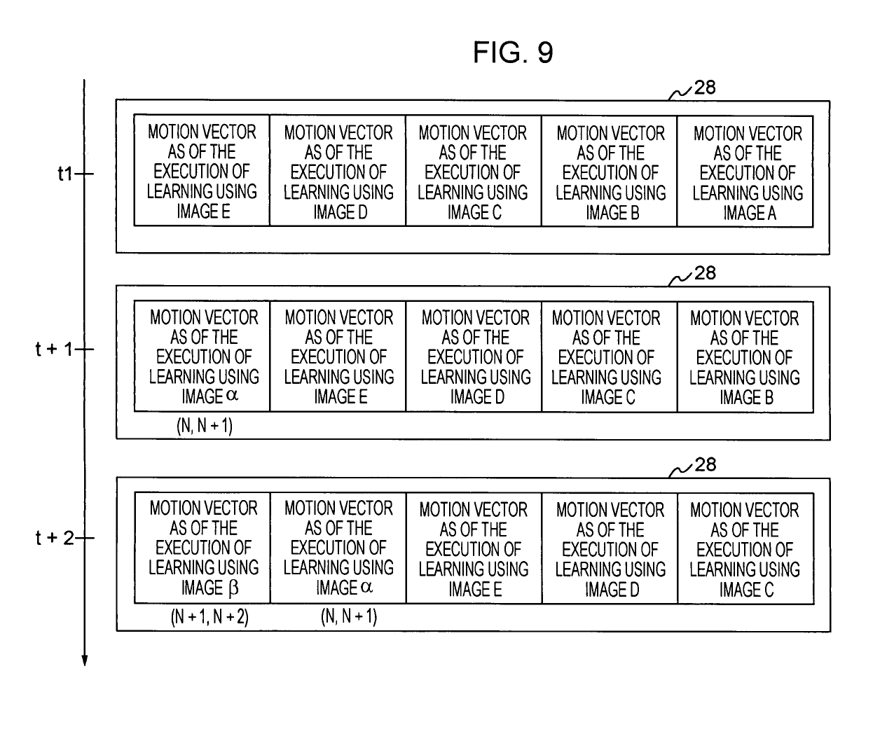

Referring to FIG. 8 and FIG. 9, the initial data stored in the motion vector code assigner 28 and a manner in which the data motion vector code assigner 28 is updated are described. FIG. 8 shows motion vector data stored in the motion vector code assigner 28 as of times t, t+1, and t+2. At time t, the motion vector code assigner 28 is in an initial state. Time t+1 is a time at which processing of one frame is just completed after the time t. Time t+2 is a time at which processing of two frames is just completed after the time t.

In the initial state at time t, motion vector data obtained as a result of learning using five images A, B, C, D, and E exist in the motion vector code assigner 28. At time t+1, processing of one frame is completed, and motion vector data obtained as a result of the processing is additionally stored in the motion vector code assigner 28. At time t+2, processing of further one frame is completed, and motion vector data obtained as a result of the processing is further stored in the motion vector code assigner 28.

As described above, motion vector data obtained as a result of learning performed beforehand using particular images exists in the motion vector code assigner 28 in the initial state, and motion vector data is additionally stored in the motion vector code assigner 28 each time motion vector data is obtained as a result of processing performed on a frame input thereafter.

If data is additionally stored each time new data is created as a result of processing performed on a new frame, the total amount of data (the amount of learning) increases. Thus, with progress in learning, the distribution of motion vectors becomes more dominated by the images input via the input terminal 21 while maintaining the robustness of the distribution of motion vectors, and the code assignment is performed in accordance with such a motion vector distribution.

However, the storage capacity of the motion vector code assigner 28 is limited, and thus it is impossible to infinitely continue to store data each time new data is created as a result of processing for a new frame. In view of the above, as shown in FIG. 9, the motion vector code assigner 28 may be configured to store a finite amount of data. In the example shown in FIG. 9, the motion vector code assigner 28 has a storage capacity that allows it to store data of a total of five images. In the initial state at time t, motion vector data obtained as a result of learning performed in advance using five images A to E exists in the motion vector code assigner 28.

At time t+1, motion vector data is created as a result of processing on a new frame. This new data is stored such that existing data of one frame is deleted to create a free storage space, and the new data is stored. In the example shown in FIG. 9, motion vector data obtained as a result of learning using an image A is deleted. At time t+2, new motion vector data is further obtained as a result of processing on a new frame. Existing motion vector data associated with an image B is deleted, and the new motion vector data is stored.

As described above, whenever new data is created, a free storage space in which to store the new data is created by deleing existing data, and the new data is stored thereby maintaining the total amount of stored data to be equal to or less than a predetermined value. In this case, although the total data size is limited, the stored data is updated and learning is performed each time new data is given, and thus it is possible to obtain a more proper calculated value with progress in the learning. That is, it is possible to eliminate influences of images with low correlations with the frame of interest while maintaining robustness in the motion vector distribution, and thus the correlation of the motion vector distribution with respect to the image input via the input terminal 21 becomes higher and higher with progress in the process.

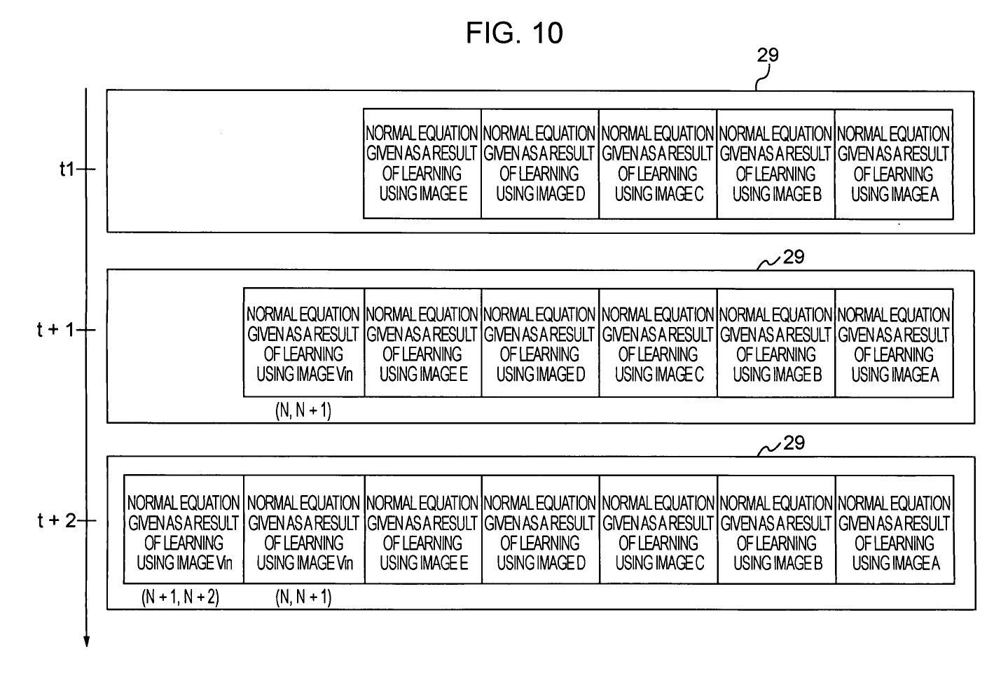

Similarly, as shown in FIG. 10, the normal equation obtained via learning using five images A to E is stored in the normal equation generator 29 in the initial state at time t. At time t+1, a normal equation obtained as a result of learning using a new input image is stored, in addition to the existing normal equations, in the normal equation generator 29. At time t+2, a further normal equation obtained via learning using a further new image is additionally stored. Thus, the coefficient data stored in the normal equation generator 29 are updated each time a new image is input and processed. Thus, with progress of the process, the coefficient data generated by the normal equation generator 29 becomes more dominated by the result of learning performed for the image input via the input terminal 21, while maintaining the robustness of the coefficient data.

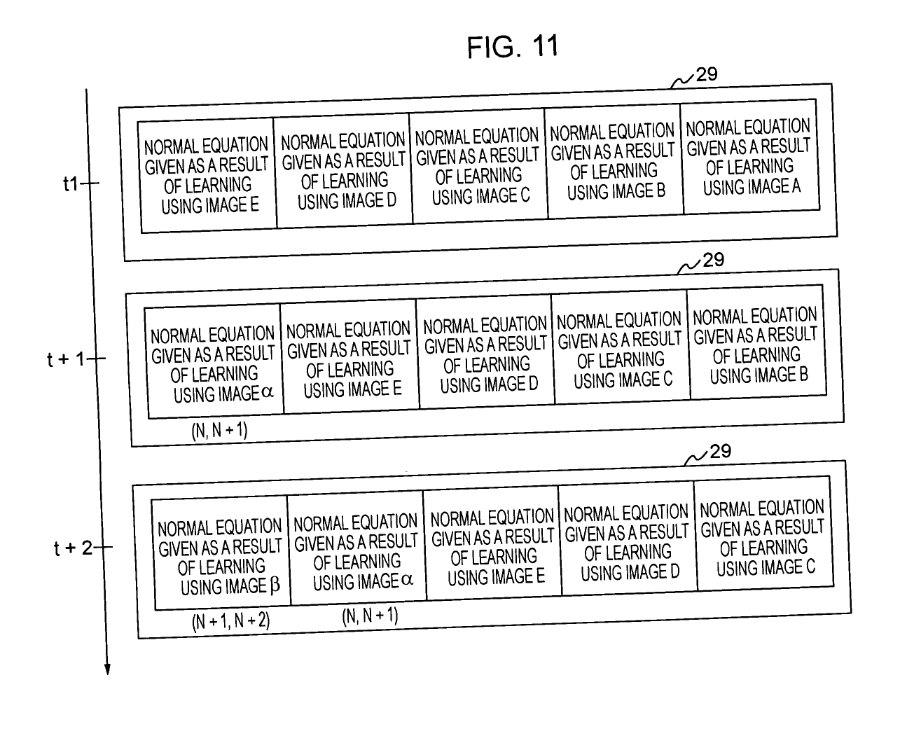

Also in this case, the normal equation generator 29 has a limited storage capacity, and thus data may be deleted as required, for example, as shown in FIG. 11. More specifically, as shown in FIG. 11, normal equations obtained via learning using images A to E are stored in the normal equation generator 29 in the initial state at time t. At each following time such as time t+1, time t+2, and so on, new data is stored and old data is deleted.

For example, as shown in FIG. 11, when the set of image data includes only initial data, if image data of frame N and image data of frame N+1 input via the input terminal 21 are newly incorporated into the set of image data, components of the normal equation associated with the initial image A and the image B are replaced with components of the normal equation associated with the newly incorporated image data. As a result, influences of images with low correlations with the frame of interest are eliminated while maintaining robustness in the motion vector distribution, and the coefficient data generated by the normal equation generator 29 becomes more dominated by the result of learning performed for the image input via the input terminal 21.

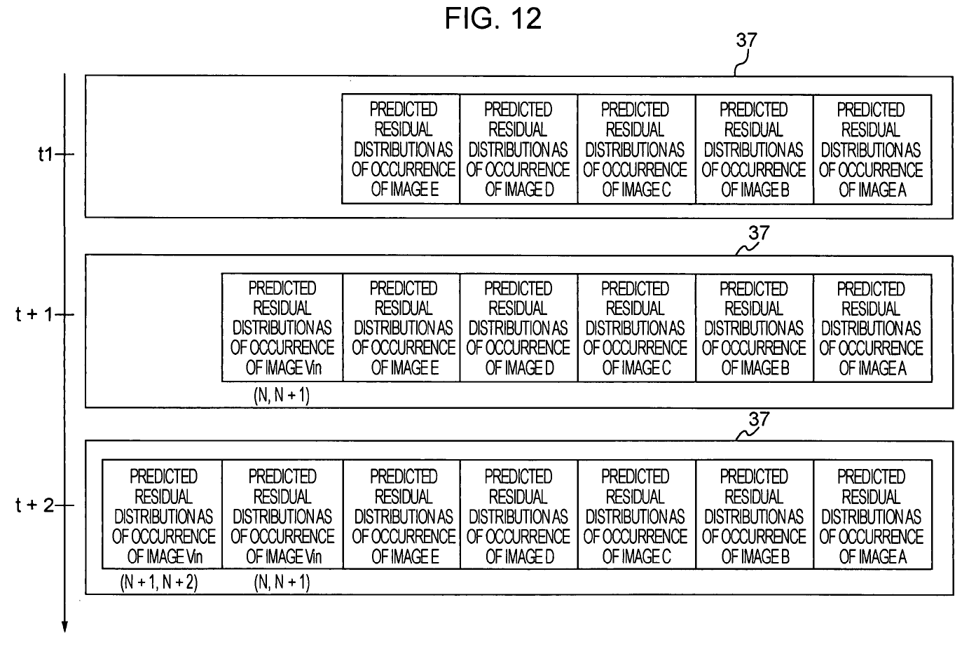

Similarly, in the residual distribution generator 37, as shown in FIG. 12, when the predicted residual distribution is given by the initial data, if image data of frame N and image data of frame N+1 are newly input via the input terminal 21, the predicted residual distribution is updated so as to includes the newly input image data. As a result, with progress in the process, the predicted residual becomes more dominated by the newly input image data while maintaining the robustness of the predicted residual distribution, and the code assignment is performed according to the varying predicted residual distribution.

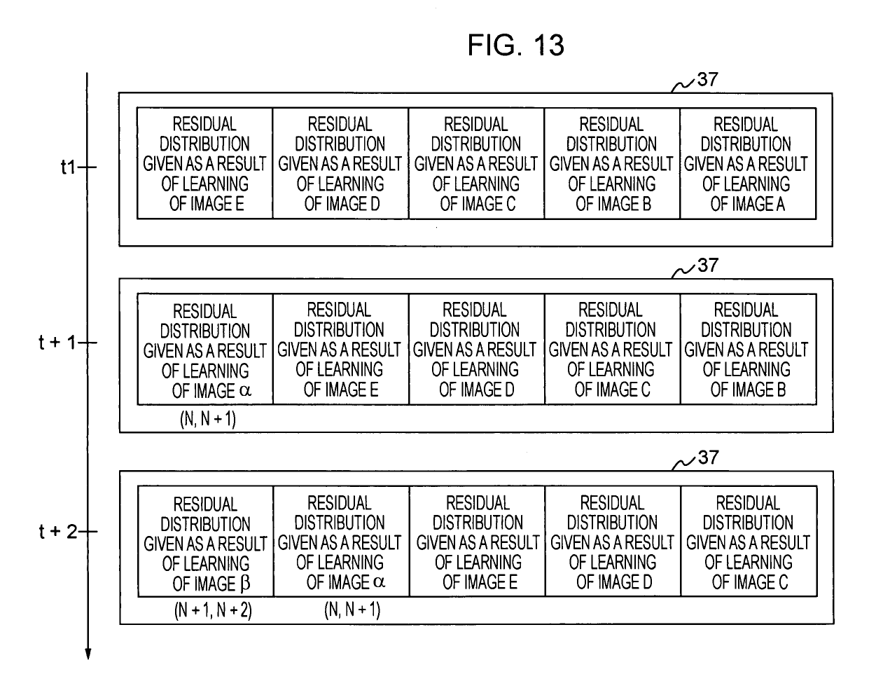

Also in this case, the storage capacity of the residual distribution generator 37 is limited, and thus data may be deleted as required, for example, as shown in FIG. 13. In the example shown in FIG. 13, when the predicted residual distribution is given by the initial data, if image data of frame N and image data of frame N+1 are newly input, then the predicted residual distribution data associated with the image A and the predicted residual distribution data associated with the image B are deleted, and the predicted residual distribution data associated with the image data of the frame N and the predicted residual distribution data associated with the image of the frame N+1 are incorporated into the set of predicted residual distribution data. As a result, influences of images with low correlations with the frame of interest are eliminated while maintaining robustness of the predicted residual distribution. That is, the code assignment is performed in accordance with the predicted residual distribution which becomes more dominated by newly input image data (having high correlation with the current frame) with the progress of the process.

Note that in FIG. 13, the predicted residuals for the respective images A, B, C, D, and E are calculated using the coefficient data obtained from the normal equation stored in the initial state in the normal equation generator 29. For newly input image data, the predicted residual is calculated using the coefficient data obtained from the normal equation in which the component associated with the image A is deleted from the initial normal equation and the component learnt for newly input image data of frames N and N+1 is incorporated.

As described above, initial data are stored in advance in the motion vector code assigner 28, the normal equation generator 29, and the residual distribution generator 37 in the encoding apparatus 10, and these data are updated each time new image data is input so that encoding is performed in a more proper manner with the progress of the process.

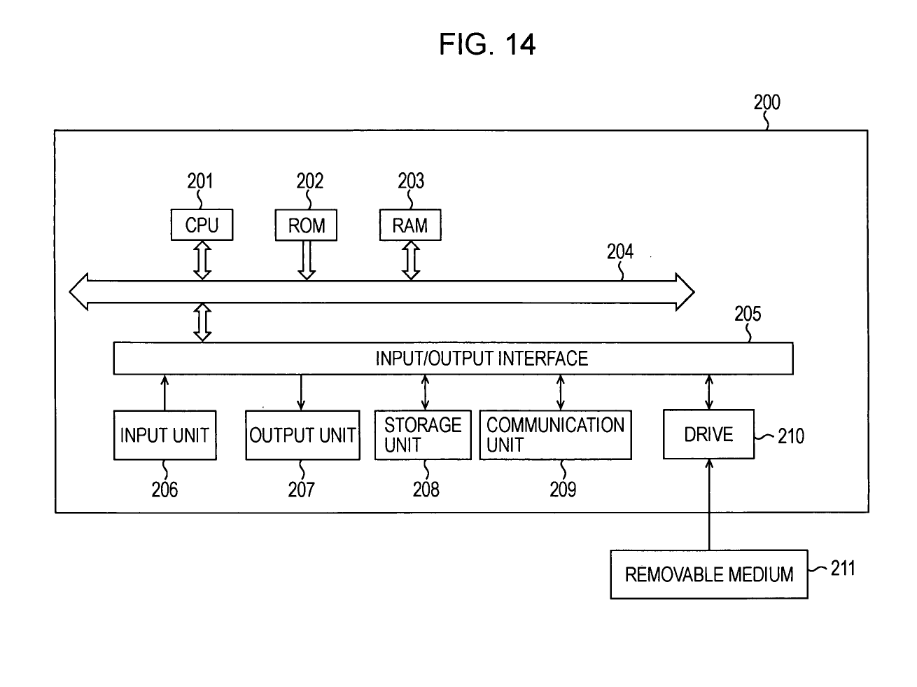

The process performed by each unit in the encoding apparatus 10 may be performed by dedicated hardware or software. In the case in which process is performed by software, the encoding may be performed on a personal computer 200 configured, for example, as shown in FIG. 14.

A CPU (Central Processing Unit) 201 in the personal computer 200 shown in FIG. 14 performs various processes in accordance with programs stored in a ROM (Read Only Memory) 202 or a storage unit 208. A RAM (Random Access Memory) 203 stores the programs executed by the CPU 201 and also stores data used in the execution of the programs. The CPU 201, the ROM 222, and the RAM 203 are connected to each other via a bus 204.

An input/output interface 205 is connected to the CPU 201 via a bus 204. The input/output interface 205 is connected to an input unit 206 including a keyboard, a mouse, a microphone, and/or the like and an output unit 207 including a display, speaker, and/or the like. The CPU 201 performs various processes in accordance with commands input via the input unit 206. A result of processes performed by the CPU 201 is output via the output unit 207.

The storage unit 208 is configured using, for example, a hard disk and is connected to the input/output interface 205. The storage unit 208 is used to store programs executed by the CPU 202 and is also used to store various kinds of data. The communication unit 209 is configured to communicate with an external apparatus via a network such as the Internet or a local area network.

A program may be acquired via the communication unit 209 and the acquired program may be stored in the storage unit 208.

The input/output interface 205 is also connected to a drive 210. A removable storage medium 211 such as a magnetic disk, an optical disk, a magnetooptical disk, or a semiconductor memory is mounted on the drive 210 as required, and a computer program or data is read from the removable storage medium 211 and transferred to the storage unit 208, as required.

In the personal computer 200 configured in the above-described manner, the encoding process is performed by the CPU 201 in accordance with the program stored in the storage unit 208 or the ROM 202. That is, each unit in the encoding apparatus 10 is implemented by executing the program on the CPU 201. However, the frame memory 22 and the frame memory 23 are implemented by the RAM 203 or the storage unit 208.

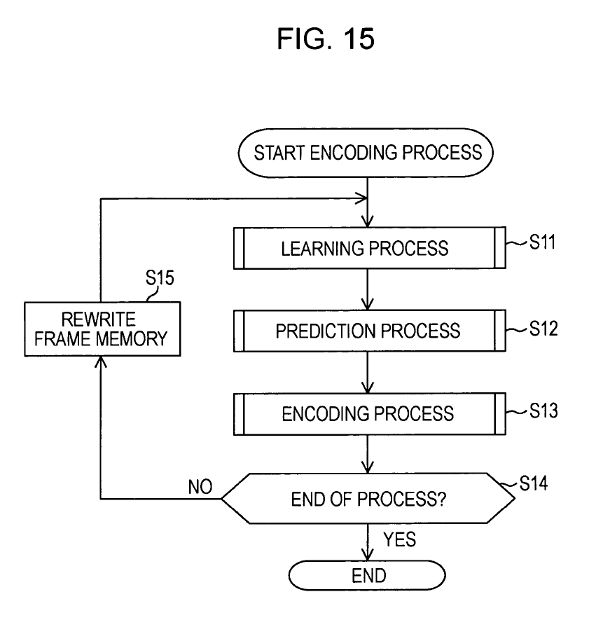

The encoding process performed by the encoding apparatus 10 shown in FIG. 1, which may be implemented by hardware or software, is described below with reference to flow charts shown in FIGS. 15 to 18. In the following description, by way of example, it is assumed that the encoding process is performed by the encoding apparatus 10 implemented by software.

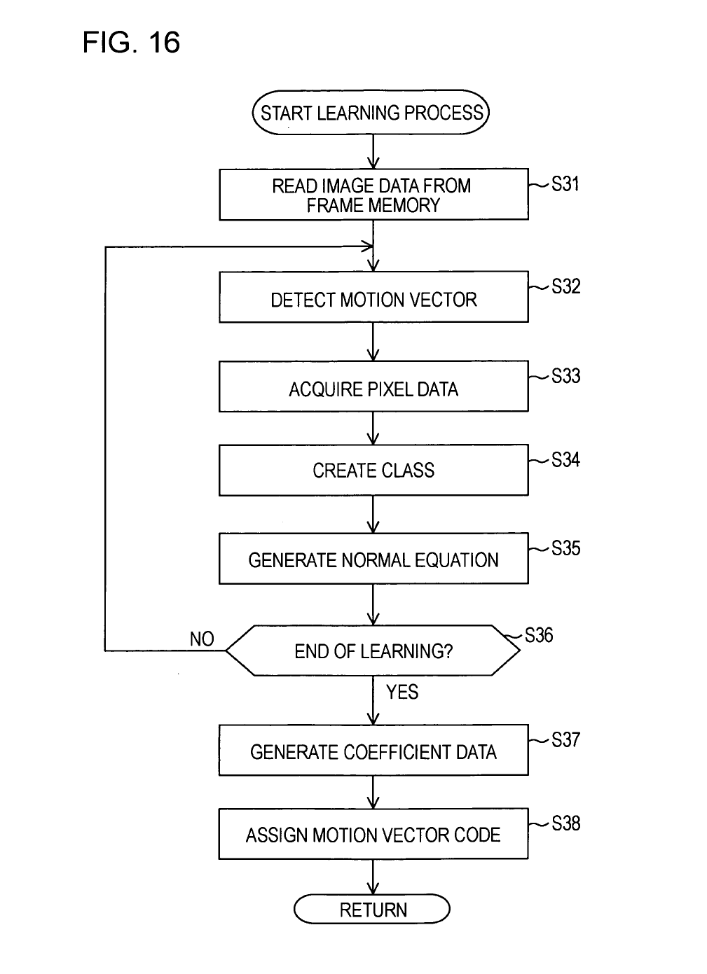

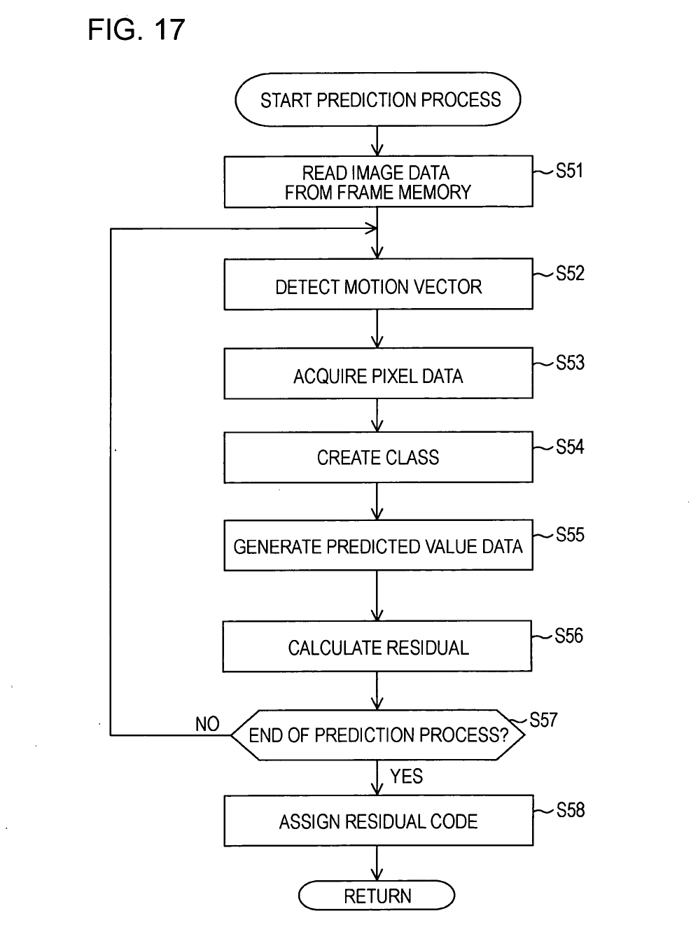

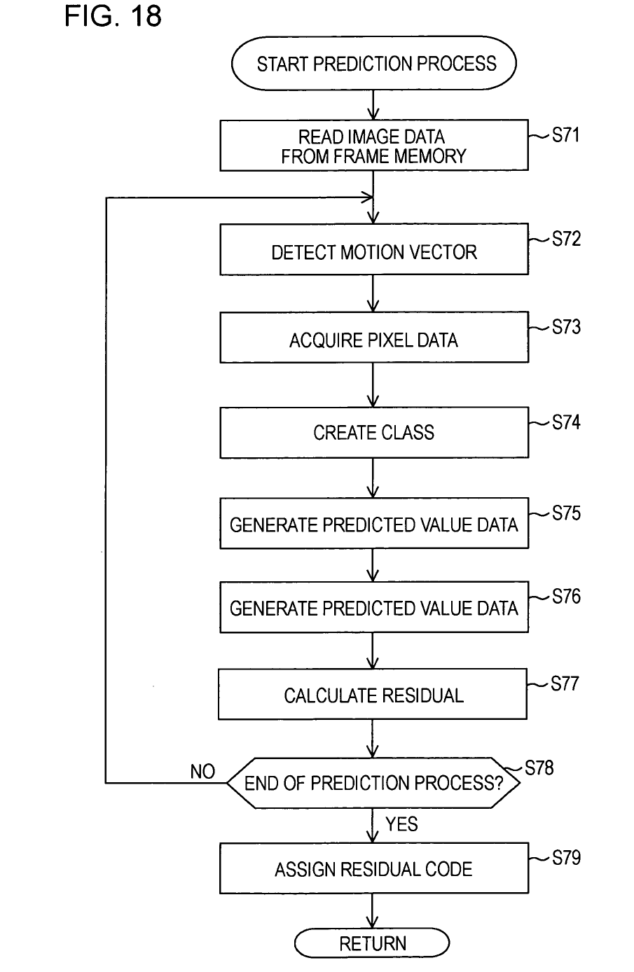

In step S11, a learning process is performed to calculate prediction coefficients. The details of the learning process will be described below with.reference to a flow chart shown in FIG. 16. In step S12, a prediction process is performed to make a prediction using the prediction coefficients. The details of the prediction process will be described later with reference to a flow chart shown in FIG. 17. In step S13, an encoding process is performed to encode the motion vector and the residual. The details of the encoding process will be described later with reference to a flow chart shown in FIG. 18.

In step S14, it is determined whether the sequence of processes is completed. In this step S14, an affirmative answer is given, for example, when there is no more input image data. If it is determined in step S14 that the sequence of processes is not yet completed, the processing flow proceeds to step S15. In step S15, the image data stored in the frame memories 22 and 23 are rewritten.

More specifically, the frame of interest, the process for which has been completed, is stored in the frame memory 22, and the frame stored in the frame memory 22 is transferred to the frame memory 23 thereby rewriting the image data stored in the frame memory 22 and the frame memory 23.

If the rewriting of the image data stored in the frame memories 22 and 23 is completed, the processing flow returns to step S11 to repeat the process described above. Note that the encoding process described above is performed repeatedly as long as image data is being input.

With reference to a flow chart shown in FIG. 16, the details of the learning process performed in step S11 are described below. In step S31, image data is read from the frame memories 22 and 23. Note that the image data read from the frame memory 22 is image data of a frame which is one frame before the current input image data, and the image data read from the frame memory 23 is image data of a frame which is two frames before the current input image data.

In step S32, the motion vector is calculated using the frame image data read from the frame memories 22 and 23. In step S33, pixel data of pixels (taps) associated with the pixel of interest (being processed) are acquired using the calculated (detected) motion vector. More specifically, pixel data of a plurality of pixels close in position to the pixel of interest are acquired.

In next step S34, the class is determined from the pixel data acquired in step S33. In step S35, learning is performed so as to minimize the prediction error for the pixel of interest, and a normal equation is generated. In step S36, it is determined whether the learning process is completed for all pixels. If it is determined in step S36 that the learning process is not yet completed for all pixels, the processing flow returns to step S32 to repeat the process from step S32.

On the other hand, in a case in which it is determined in step S36 that the learning process is completed for all pixels, the processing flow proceeds to step S37. In step S37, the coefficient data is determined by solving the normal equation generated in step S35, and the resultant coefficient data is stored. Thereafter, in step S38, codes for motion vectors are assigned according to the motion vector distribution determined via the learning, and the assigned codes are stored. The learning on the assignment in terms of the coefficient data and the motion vector is performed in the above-described manner and the result is stored.

After the learning process described above, the prediction process is performed in step S12. The details of the prediction process in step S12 are described below with reference to a flow chart shown in FIG. 17.

In step S51, image data is read from the frame memories 22 and 23. In step S52, a motion vector is detected using the image data read from the frame memories 22 and 23. In step S53, image data of pixels (taps) associated with the pixel of interest are acquired using the motion vector detected in step S52.

In step S54, the class is determined (generated) from the pixel data acquired in step S53. In step S55, a predicted value is calculated on the basis of the pixel data acquired in step S53 and the coefficient data determined in step S37 (FIG. 16). In step S56, the residual between the predicted value and the pixel value of the pixel of interest is calculated. In step S57, it is determined whether the prediction process is completed for all pixels.

If it is determined in step S57 that the prediction process is not yet completed for all pixels, the processing flow returns to step S52 to repeat the process from step S52. On the other hand, in a case in which it is determined in step S57 that the prediction process is completed for all pixels, the processing flow proceeds to step S58.

In step S58, codes are assigned to residuals of each class according to the residual distribution collected for each class, and the assigned codes are stored.

After the prediction process described above, the encoding of the frame of interest is performed step S13. The details of the encoding process in step S13 are described below with reference to a flow chart shown in FIG. 18.

In step S71, image data of a frame to be processed is input (acquired). In step S72, a motion vector of the input frame with respect to the frame stored in the frame memory 22 is detected. In step S73, pixel data of pixels associated with the pixel of interest are acquired using the motion vector detected in step S72. In step S74, the class is determined from the pixel data acquired in step S73.

In step S75, a predicted value for the pixel of interest is calculated using the pixel data acquired in step S73 and the coefficient data determined in step S37 (FIG. 16). In step S76, the residual between the predicted value and the pixel value (true pixel value) of the pixel of interest is calculated. In step S77, the residual is encoded according to the code assignment determined in step S58 (FIG. 17).

In step S78, it is determined whether the encoding of the residual is completed for all pixels. If the answer to step S78 is that the encoding of the residual is not yet completed for all pixels, the processing flow returns to step S72 to repeat the process from step S72. On the other hand, if the answer to step S78 is that the encoding of the residual is completed for all pixels, then the process proceeds to step S79. In step S79, the motion vector is encoded according to the code assignment determined in step S38 (FIG. 16).

In the encoding process according to the present embodiment, as described above, a second frame (for example, the frame stored in the frame memory 22 shown in FIG. 1) is predicted from a first frame (for example, the frame stored in the frame memory 23 shown in FIG. 1), and prediction coefficients are calculated on the basis of the prediction. A predicted image is then produced using the calculated prediction coefficients and a third frame (which may be same as the second frame, that is, the frame stored in the frame memory 22 in this specific example).

The residual between a current frame to be encoded and the resultant predicted image is calculated, the residual is encoded, and the encoded residual is transmitted to a decoding apparatus. The decoding apparatus, which receives such an encoded residual and such a motion vector, is described below.

Configuration of Decoding Apparatus

FIG. 19 shows a configuration of the decoding apparatus according to an embodiment of the present invention. As shown in FIG. 19, the decoding apparatus 310 includes an input terminal 321, a frame memory 322, a frame memory 323, a blocking unit 324, a motion vector detector 325, a tap selector 326, a class detector 327, a motion vector code assigner 328, a normal equation generator 329, a coefficient determiner 330, a blocking unit 331, a motion vector detector 332, a tap selector 333, a class detector 334, a coefficient memory 335, a predictor 336, a residual distribution generator 337, a residual code assigner 338, a data divider 339, a motion vector decoder 340, a tap selector 341, a class detector 342, a predictor 343, a residual adder 344, a blocking unit 345, residual decoder 346, and an output terminal 347.

A data flow in the decoding apparatus 310 is described first, and then the operation of each unit in this decoding apparatus 310 and data created by each unit are described.

Data input via the input terminal 321 is supplied to the data divider 339. Data output from the data divider 339 is supplied to the motion vector decoder 340 and the residual decoder 346. Data output from the motion vector decoder 340 is supplied to the tap selector 341. Data output from the tap selector 341 is supplied to the class detector 342 and the predictor 343. Data output from the class detector 342 is supplied to the coefficient memory 335 and the residual decoder 346.

Data output from the predictor 343 is supplied to the residual adder 344. Data output from the residual adder 344 is supplied to the blocking unit 345. Data output from the blocking unit 345 is supplied to the frame memory 322, the tap selector 341, and the output terminal 347. Data output from the residual decoder 346 is supplied to the residual adder 344.

Data output from the frame memory 322 is supplied to the frame memory 323, the blocking unit 324, the blocking unit 331, and the tap selector 341. Data output from the frame memory 323 is supplied to the motion vector detector 325, the tap selector 326, the motion vector detector 332, and the tap selector 333.

Data output from the blocking unit 324 is supplied to the motion vector detector 325, the tap selector 326, and the normal equation generator 329. Data output from motion vector detector 325 is supplied to the tap selector 326 and the motion vector code assigner 328. Data output from the tap selector 326 is supplied to the class detector 327 and the normal equation generator 329. Data output from the class detector 327 is supplied to the normal equation generator 329.

Data output from the motion vector code assigner 328 is supplied to the motion vector decoder 340. Data output from the normal equation generator 329 is supplied to the coefficient determiner 330. Data output from the coefficient determiner 330 is supplied to the coefficient memory 335.

Data output from the blocking unit 331 is supplied to the motion vector detector 332, the tap selector 333, and the residual distribution generator 337. Data output from the motion vector detector 332 is supplied to the tap selector 333. Data output from the tap selector 333 is supplied to the class detector 334 and the predictor 336. Data output from the class detector 334 is supplied to the coefficient memory 335 and the residual distribution generator 337.

Data output from the coefficient memory 335 is supplied to the predictor 336 and the predictor 343. Data output from the predictor 336 is supplied to the residual distribution generator 337. Data output from the residual distribution generator 337 is supplied to the residual code assigner 338. Data output from the residual code assigner 338 is supplied to the residual decoder 346.

In the decoding apparatus 310 shown in FIG. 19, data is transferred in the above-described manner.

The decoding apparatus 310, which is constructed in the above-described manner and in which data is transferred in the above-described manner, can be roughly divided in three main units: a learning unit 361, a prediction unit 362, and a decoding unit 363, as shown in FIG. 20. The learning unit 361 includes the blocking unit 324, the motion vector detector 325, the tap selector 326, the class detector 327, the motion vector code assigner 328, the normal equation generator 329, and the coefficient determiner 330. That is, block units located in an upper left area of the block diagram shown in FIG. 19 are main components of the learning unit 361.

The prediction unit 362 includes the blocking unit 331, the motion vector detector 332, the tap selector 333, the class detector 334, the coefficient memory 335, the predictor 336, the residual distribution generator 337, and the residual code assigner 338. That is, block units located in an upper right area of the block diagram shown in FIG. 19 are main parts of the prediction unit 362.

The decoding unit 363 includes the data divider 339, the motion vector decoder 340, the tap selector 341, the class detector 342, the predictor 343, the residual adder 344, the blocking unit 345, and the residual decoder 346. That is, block units located in a lower area of the block diagram shown in FIG. 19 are main parts of the decoding unit 363.

The operation of each unit in the decoding apparatus 310 shown in FIG. 19 is described below.

As shown in FIG. 19, the decoding apparatus 310 includes the frame memory 322 and the frame memory 323. The frame memory 322 is configured to image data (of a frame) which appeared one frame before current encoded image data Vcd input via the input terminal 321 and which has already been decoded. The frame memory 323 is configured to image data (of a frame) which appeared two frames before the current encoded image data Vcd input via the input terminal 321 and which has already been decoded.

Hereinafter, the frame which is input via the input terminal 321 and which is to be subjected to the decoding process is denoted as a frame N, the frame stored in the frame memory 322 is denoted as a frame N−1, and the frame stored in the frame memory 323 is denoted as a frame N−2. The current frame which is input via the input terminal 321 and which is currently being subjected to the decoding process will also be referred to as a frame of interest.

The blocking unit 324 divides the frame stored in the frame memory 322 into a plurality of blocks with a predetermined size. The blocking unit 324 performs a blocking process in a similar manner to that performed by the blocking unit 24 of the encoding apparatus 10 shown in FIG. 1. More specifically, as described above with reference to FIG. 3, the blocking unit 324 divides one frame of image data (representing an image of an effective screen) stored in the frame memory 322 into a plurality of blocks (in FIG. 3, each square unit area surrounded by lines represents one block) each including a total of 64 pixels arranged in the form of an array including eight horizontal rows and eight vertical columns.

Although in the present embodiment, one block is assumed to include a total of 64 pixels in the form of an 8×8 array, there is no restriction on the number of pixels. The resultant blocks of the frame N−1 are supplied from the blocking unit 324 to the motion vector detector 325.

In addition to the frame N−1 divided into blocks by the blocking unit 324, the frame N−2 stored in the frame memory 323 is also supplied to the motion vector detector 325. The motion vector detector 325 detects the motion vector of each block of the frame N−1 supplied from the blocking unit 324 with respect to the frame N−2 stored in the frame memory 323. The detection of the motion vector is performed in a similar manner to that performed by. the motion vector detector 25 of the encoding apparatus 10 shown in FIG. 1, and thus a further detailed explanation thereof is omitted herein.

The motion vector detected by the motion vector detector 325 is supplied to the tap selector 326 and the motion vector code assigner 328. The tap selector 326 receives the frame N−2 from the frame memory 323, the blocks divided by the blocking unit 324, and the motion vector detected by the motion vector detector 325, and the tap selector 326 selects pixels (pixel data of the pixels) by performing a process similar to that performed by the tap detector 26 of the encoding apparatus 10 shown in FIG. 1.

The pixel data of pixels extracted by the tap selector 326 is supplied to the class detector 327 and the normal equation generator 329. The class detector 327 creates a class for the pixel data extracted by the tap selector 327 (that is, the class detector 327 classifies the pixel data) in accordance with the feature value of the pixels. More specifically, as with the class detector 27 of the encoding apparatus 10 shown in FIG. 1, the class detector 327 creates the class for the pixel data by performing ADRC (Adaptive Dynamic Range Coding)on the extracted pixel data. The class detected by the class detector 327 is supplied to the normal equation generator 329.

The normal equation generator 329 generates a normal equation by means of learning from the block of interest supplied from the blocking unit 324, the pixel data extracted by the tap selector 326 and the class determined by the class detector 327. The generation of the normal equation is performed in a similar manner to that performed by the normal equation generator 29 shown in FIG. 1, and thus a further detailed explanation thereof is omitted herein.

The coefficient determiner 330 solves the normal equations generated by the normal equation generator 329 by using a sweeping out method (also called a Gauss-Jordan elimination method) or the like with respect to prediction coefficients wᵢ (equation (7)) thereby determining the coefficient data. The coefficient memory 335 stores the coefficient data determined by the coefficient determiner 330 for each class.

The motion vector code assigner 328 stores all motion vectors detected by the motion vector detector 325 for all blocks given by the blocking unit 324. The motion vector code assigner 328 assigns a code to each motion vector according to a motion vector distribution, for example, using a Huffman code.

The blocking unit 331 performs a process similar to the process performed by the blocking unit 324. More specifically, the blocking unit 331 divides the frame N−1 stored in the frame memory 322 into a plurality of block each including 64 pixels (that is, the blocking unit 331 divides the frame N−1 processed by the blocking unit 324 in the same manner as the manner in which the blocking unit 324 divides the frame N−1). The blocks output from the blocking unit 331 is supplied to the motion vector detector 332 and the tap selector 333.

The motion vector detector 332 performs a process similar to that performed by the motion vector detector 325 to detect a motion vector for each block supplied from the blocking unit 331 with respect to the frame stored in the frame memory 323. The motion vector detected by the motion vector detector 332 is supplied to the tap selector 333.

The tap selector 333 performs a process similar to that performed by the tap selector 326 to extract particular pixels (pixel data) from the block of interest supplied from the blocking unit 331, the frame N−2 stored in the frame memory 323, and the motion vector detected by the motion vector detector 325. The pixel data of pixels extracted by the tap selector 333 is supplied to a class detector 334 and the predictor 336.

The class detector 334 performs a process similar to that performed by the class detector 327 to create a class (to perform classification). The class created by the class detector 334 is supplied to the coefficient memory 335 and stored therein. The class created by the class detector 34 is also supplied to the residual distribution generator 337.

The predictor 336, as with the predictor 36 of the encoding apparatus 10 shown in FIG. 1, calculates the predicted value y′ using the coefficient data read from the coefficient memory 335 for the class detected by the class detector 334 and the pixel data supplied from the tap selector 333, according to equation (7). In equation (7), xᵢ denotes the pixel data supplied from the tap selector 333, and wᵢ denotes the coefficient data supplied from the coefficient memory 335.

The residual distribution generator 337, as with the residual distribution generator 37 of the encoding apparatus 10 shown in FIG. 1, calculates the residual between the value of each pixel of interest supplied from the blocking unit 331 and the corresponding predicted value supplied from the predictor 336 and stores a distribution of residuals for each class, for example, as shown in FIG. 7.

The residual code assigner 338, as with the residual code assigner 38 of the encoding apparatus 10 shown in FIG. 1, assigns codes to residuals for each class according to the residual distribution stored in the residual distribution generator 337, by using, for example, Huffman codes. That is, codes are assigned according to the residual distribution for each class.

The configurations and the operations of the respective units from the frame memory 322 to the residual code assigner 338 are similar to those of the units from the frame memory 22 to the residual code assigner 38 in the encoding apparatus 10. When the frame N is being subjected to the decoding process, the frames stored in the frame memory 322 and frame memory 323 are respectively the frame N−1 and the frame N−2. Note that the frames N−1 and N−2 are the same frames as those which are stored in the frame memory 22 and the frame memory 23 when the frame N is encoded in the encoding apparatus 10.

That is, because the frames stored in the frame memories in the decoding process are the same as those stored in the encoding process, and the decoding process is performed by the decoding apparatus which is similar in configuration to the encoding unit, codes are assigned according to the residual distribution for each class in a similar manner as in the encoding process. The codes assigned by the motion vector code assigner 328 are also the same as those assigned in the encoding apparatus 10. Furthermore, the coefficient data stored in the coefficient memory 335 is the same as the coefficient data stored in the decoding apparatus 10.

As described above, the same state occurs in the decoding apparatus 310 as the state in the encoding apparatus 10. After the learning and the prediction are performed in the above-described manner, decoding is performed using the results thereof.

The data divider 339 divides image data Vcd input via the input terminal 321 into encoded residual data Vcdo and encoded vector data Vcdmv. The resultant residual data Vcdo is supplied to the residual decoder 346, and the motion vector data Vcdmv is supplied to the motion vector decoder 340.

The motion vector decoder 340 decodes the encoded motion vector data Vcdmv supplied from the data divider 339 by using the code determined by the motion vector code assigner 328, and supplies motion vector data obtained as a result of the decoding to tap selector 341.

The tap selector 341 performs a process similar to that performed by the tap selector 41 in the encoding apparatus 10 shown in FIG. 1 to extract pixel data of particular pixels. More specifically, as shown in FIG. 6, for each pixel in the block 101 of interest, the tap selector 341 selects pixel data of pixels from the block 101 of interest and from the detected block 104 determined from the frame stored in the frame memory 322 and the motion vector supplied from the motion vector decoder 340 (in the example shown in FIG. 6, a total of eleven pixels including pixels 131 to 136 and pixels 141 to 145 are selected).

Note that in the block 101 of interest, because the decoding is performed in the same order as the order in which raster scanning is performed, pixels located to the left of or above the pixel of interest have already been subjected to decoding, and the pixels at these locations are supplied from the blocking unit 345.

The class detector 342, as with the class detector 42 of the encoding apparatus 10 shown in FIG. 1, performs the classification according to the feature value of the pixels using the pixel data extracted by the tap selector 341. Note that the class detector 342 is configured in a similar manner to the class detector 327.

The predictor 343 calculates the predicted value y′according to equation (8) using the coefficient data read from the coefficient memory 335 for the class detected by the class detector 342 and the pixel data supplied from the tap selector 341. The calculated predicted value y′ is supplied to the residual adder 344.

The residual adder 344 adds the value represented by the residual data supplied from the residual decoder 346 to the predicted value supplied from the predictor 343. The resultant value is supplied to the blocking unit 345. The blocking unit 345 returns the pixel data of the pixel of interest supplied from the residual adder 344 to a particular location.

The pixel data which has already been decoded is used in the decoding of a next pixel of interest. Therefore, the decoded pixel data is sequentially supplied to the tap selector 341. When the process for the encoded image data Vcd input via the input terminal 321 is completed, the data stored in the frame memory 322 is transferred to the frame memory 323, the data decoded by the blocking unit 345 is stored in the frame memory 322.

The data output from the blocking unit 345 is supplied as the decoded data to the output terminal 347.

At the point of time at which a first or second frame is input as the image data via the input terminal 321, no frame exists in the frame memory 322 or 323, and thus the decoding process cannot be performed in the above-described manner. Therefore, for the first and second frames input via the input terminal 321, the decoding is performed in a different manner. That is, decoding which is inverse of lossless encoding performed in the encoding apparatus 10 is performed.

In the initial state, the normal equation generator 329, the residual distribution generator 33, and the motion vector code assigner 328 respectively have initial data which are the same as those initially stored in the normal equation generator 29, the residual distribution generator 37, and the motion vector code assigner 28 in the encoding apparatus 10. That is, data similar to those described above with reference to FIGS. 8 to 13 are stored as initial data. As described above with reference to FIGS. 8 to 13, with progress of the process, the data stored in these units are updated. When data is updated, existing data is deleted as required, as with the encoding apparatus 10.

The process performed by each unit in the decoding apparatus 310 may be performed by dedicated hardware or software. In the case in which process is performed by software, the decoding may be performed on a personal computer 200 configured, for example, as shown in FIG. 14.

In the case in which the decoding described above is performed on the personal computer 200 configured as shown in FIG. 14, the encoding is performed by the CPU 201 by executing a process according to a program stored in the storage unit 208 or the ROM 202. In this case, each unit in the decoding apparatus 310 shown in FIG. 19 is implemented by executing the program on the CPU 201. However, the frame memory 322 and the frame memory 323 are implemented by the RAM 203 or the storage unit 208.

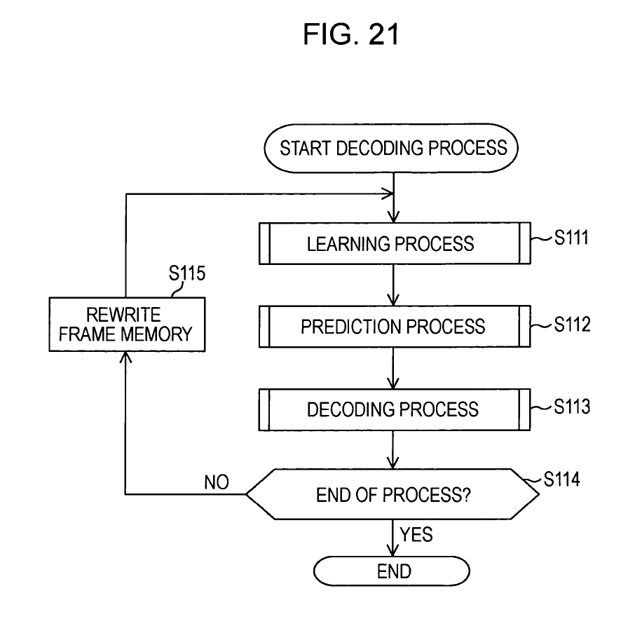

The decoding process performed by the decoding apparatus 310 shown in FIG. 19, which may be implemented by hardware or software, is described below with reference to flow charts shown in FIGS. 21 to 24.

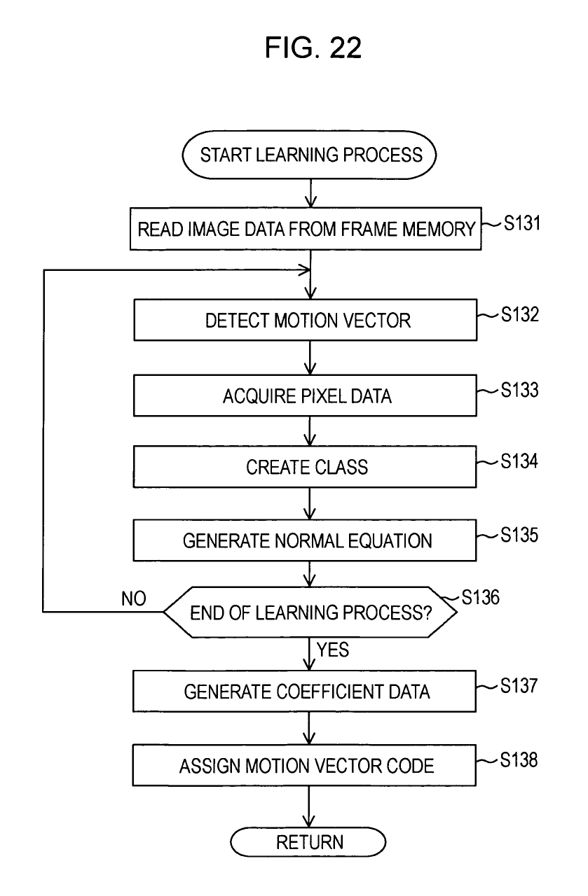

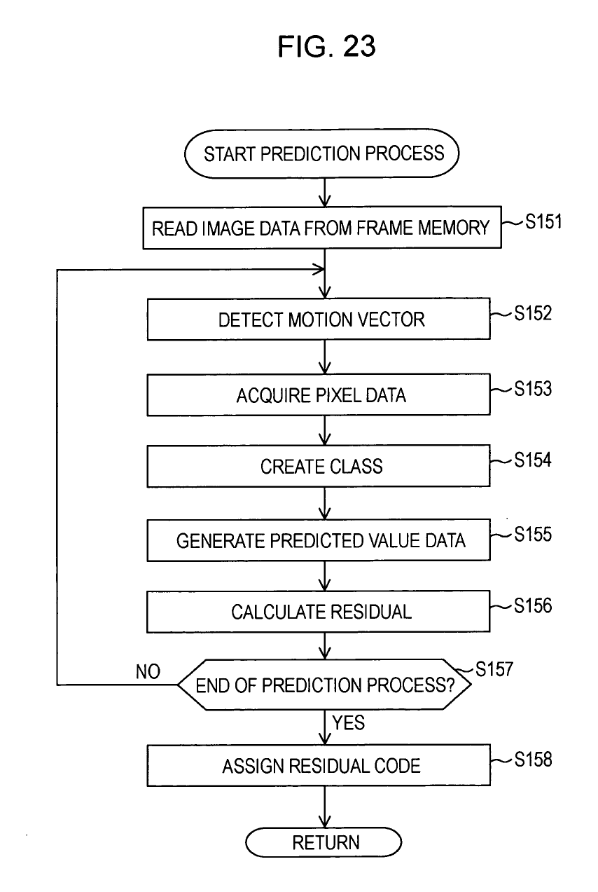

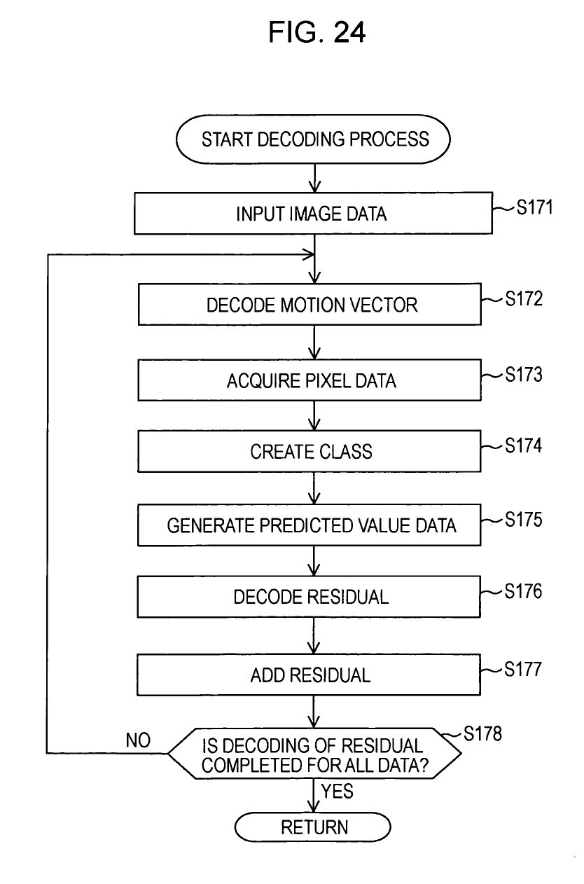

In step S111, a learning process is performed The details of the learning process will be described later with reference to a flow chart shown in FIG. 22. In step S112, a prediction process is performed. The details of the prediction process will be described later with reference to a flow chart shown in FIG. 23. In step S113, a decoding process is performed. The details of the decoding process will be described later with reference to a flow chart shown in FIG. 24.

In step S114, it is determined whether the sequence of processes is completed. An affirmative answer to this step S114 is given, for example, when no more encoded image data (image signal) is input. If it is determined in step S114 that the sequence of processes is not yet completed, the processing flow proceeds to step S115. In step S115, the image data stored in the frame memories 322 and 323 are rewritten.

More specifically, the frame of interest, the process for which has been completed, is stored in the frame memory 322, and the frame stored in the frame memory 322 is transferred to the frame memory 323 thereby rewriting the image data stored in the frame memory 322 and the frame memory 323.

If the rewriting of the image data stored in the frame memories 322 and 323 is completed, the processing flow returns to step S111 to repeat the process from step S111.

Referring to a flow chart shown in FIG. 22, the details of the learning process performed in step S111 are described below. In step S131, image data is read from the frame memories 322 and 323. Note that the image data read from the frame memory 322 is that of the frame which was input one frame before the encoded image data Vcd being currently input via the input terminal 321 and which has already been decoded, and the image data read from the frame memory 323 is that of the frame which was input two frames before the encoded image data Vcd being currently input via the input terminal 321 and which has already been decoded.

In step S132, the motion vector is calculated using the frame image data read from the frame memories 322 and 323. In step S133, pixel data of pixels (taps) associated with the pixel of interest (being processed) are acquired using the calculated (detected) motion vector. More specifically, pixel data of a plurality of pixels close in position to the pixel of interest are acquired.

In step S134, the class is determined from the pixel data acquired in step S133. In step S135, learning is performed so as to minimize the prediction error for the pixel of interest, and a normal equation is generated. In step S136, it is determined whether the learning process is completed for all pixels. If it is determined in step S136 that the learning process is not yet completed for all pixels, the processing flow returns to step S132 to repeat the process from step S132.

On the other hand, in a case in which it is determined in step S136 that the learning process is completed for all pixels, the processing flow proceeds to step S137. In step S137, the coefficient data is determined by solving the normal equation generated in step S135. In step S138, a code is assigned to the motion vector according to the motion vector distribution determined via the learning.

The learning process in the flow chart shown in FIG. 22 is performed in a similar manner as described above with reference to the flow chart shown in FIG. 16. The learning process performed herein by the decoding apparatus 310 according to the flow chart shown in FIG. 22 is similar to the learning process performed by the encoding apparatus 10. Therefore, for the same frame, the codes assigned to the coefficient data and the motion vector as a result of the learning in the decoding apparatus 310 are the same as those assigned in the encoding apparatus 10. Thus, the same state as that in the encoding apparatus 10 is reproduced in the decoding apparatus 310. This ensures that the same data as that encoded by the encoding apparatus 10 is obtained via the decoding process performed by the decoding apparatus 310.

After the learning process described above, the prediction process is performed in step S112. The details of the prediction process performed in step S112 are described below with reference to the flow chart shown in FIG. 23.

In step S151, image data is read from the frame memories 322 and 323. In step S152, a motion vector is detected using the image data read from the frame memories 322 and 323. In step S153, image data of pixels (taps) associated with the pixel of interest are acquired using the motion vector detected in step S152.

In step S154, the class is determined (generated) from the pixel data acquired in step S153. In step S155, the predicted value is calculated on the basis of the pixel data acquired in step S113 and the coefficient data determined in step S137 (FIG. 22). In step S156, the residual between the predicted value and the pixel value of the pixel of interest is calculated. In step S157, it is determined whether the prediction process is completed for all pixels.

If it is determined in step S157 that the prediction process is not yet completed for all pixels, the processing flow returns to step S152 to repeat the process from step S152. On the other hand, in a case in which it is determined in step S157 that the prediction process is completed for all pixels, the processing flow proceeds to step S158.

In step S158, codes are assigned to residuals of each class according to the data of the residual distribution collected for each class.

The prediction process described in the flow chart shown in FIG. 23 is performed in a similar manner to the prediction process performed according to the flow chart shown in FIG. 17. That is, the prediction process performed herein by the decoding apparatus 310 according to the flow chart shown in FIG. 23 is similar to the prediction process performed by the encoding apparatus 10. Therefore, for the same frame, the codes are assigned, as a result of the prediction, to the residuals for each class in the decoding apparatus 310 are the same as those assigned in the encoding apparatus 10. Thus, the same state as that in the encoding apparatus 10 is reproduced in the decoding apparatus 310. This ensures that the same data as that encoded by the encoding apparatus 10 is obtained via the decoding process performed by the decoding apparatus 310.

After the prediction process described above, the decoding of the frame of interest is performed in step S113 as described in detail below with reference to the flow chart shown in FIG. 24.

In step S171, image data of a frame to be processed is input (acquired). In step S172, data of the motion vector is decoded according to the motion vector code assignment determined in step S138 (FIG. 22). In step S173, pixel data of pixels associated with the pixel of interest are acquired using the motion vector decoded in step S172. In step S174, the class is determined from the pixel data acquired in step S173.

In step S174, the predicted value for the pixel of interest is calculated on the basis of the pixel data acquired in step S173 and the coefficient data determined in step S137 (FIG. 22). In step S176, the residual is decoded according to the code assignment determined in step S158 (FIG. 23). In step S177, the residual decoded in step S176 is added to the predicted value produced in step S175.

Note that the predicted value produced in step S174 is the same as the value predicted in the encoding apparatus 10, because, as described above, the values obtained in the learning process and the prediction process (the values used to calculate the predicted values) are the same as those used in the encoding apparatus 10. By adding the residual to the predicted value in the above-described manner, it is possible to calculate the original (true) value in the state in which the encoding by the encoding apparatus 10 was not yet performed. That is, it is possible to decode the encoded data to obtain the original data.

In step S178, it is determined whether the decoding of the residual is completed for all pixels. If the answer to step S178 is that the decoding of the residual is not yet completed for all pixels, the processing flow returns to step S172 to repeat the process from step S172. On the other hand, if the answer to step S178 is that the encoding of the residual is completed for all pixels, the processing flow proceeds to step S114 (FIG. 21).

In the present embodiment, as described above, the decoding is performed on the basis of the encoded residual and the encoded motion vector supplied from the encoding apparatus.

More specifically, in the present embodiment, the decoding is performed such that a second frame (for example, the frame stored in the frame memory 323 shown in FIG. 19) is predicted from a first frame (for example, the frame stored in the frame memory 322 shown in FIG. 19), and prediction coefficients are calculated on the basis of the prediction. A predicted image is then produced using the calculated prediction coefficients and a third frame (which may be same as the second frame, that is, the frame stored in the frame memory 322 in this specific example).

The encoded residual received from the encoding apparatus 10 is then decoded and the resultant decoded residual is added to the predicted image thereby obtaining a decoded current frame.

In the present embodiment, as described above, lossess encoding is performed such that prediction is performed according to the characteristics of an image and code assignment is performed according to the distribution of residuals that occur as a result of the prediction. In the encoding process, learning is performed using information of frames which have already been encoded, prediction coefficients are calculated on the basis of the learning, and codes are assigned to residuals according to the distribution of residuals that occur when prediction is performed using the calculated prediction coefficients. Because a given frame of interest is processed such that prediction is performed using prediction coefficients that have already been calculated and encoding is performed in accordance with code assignment that has already been determined, it is possible for the decoding apparatus to perform decoding without receiving information about prediction coefficients and code assignment from the encoding apparatus. This means that although the amount of information transmitted to the decoding apparatus is small, lossless decoding is achieved.

Second Embodiment

Another embodiment is disclosed in which encoding is performed using past frames, and decoding is performed using frames which have already been decoded.

Configuration and Operation of Encoding Apparatus

FIG. 25 shows an example of a configuration of an encoding apparatus according to a second embodiment of the present invention. As shown in FIG. 25, the encoding apparatus 410 includes a residual calculator 411, a linear predictor 412, a storage unit 413, and a prediction coefficient calculator 415. The storage unit 413 includes frame memories 414-1 to 414-4. That is, the encoding apparatus 410 shown in FIG. 25 is configured so as to be capable of storing four frames.

In the encoding apparatus 410 shown in FIG. 25, data flows as follows. Image data of a frame to be process (encoded) is supplied to the residual calculator 411 and one of the frame memories 414-1 to 414-4 in the storage unit 413. In the following explanation, it is assumed that each time decoding for one frame is completed, frames stored in the frame memories 414-1 to 414-4 are rewritten such that frames older than the current frame being processed are stored in the respective frame memories 414-1 to 414-4.

A frame being processed is denoted as a frame of interest or a frame N−1. In the frame memory 414-1, a frame N−1, which is one frame before the frame N, is stored. In the frame memory 414-2, a frame N−2, which is two frames before the frame N, is stored. In the frame memory 414-3, a frame N−3, which is three frames before the frame N, is stored. In the frame memory 414-4, a frame N−4, which is four frames before the frame N, is stored.

The frames stored in the storage unit 413 are supplied to the linear predictor 412 and the prediction coefficient calculator 415, as required. More specifically, data from the frame memories 414-1 to 414-3 are supplied to the linear predictor 412, and data from the frame memories 414-1 to 414-4 are supplied to the prediction coefficient calculator 415.

Data output from the prediction coefficient calculator 415 is supplied to the linear predictor 412. Data output from the linear predictor 412 is supplied to the residual calculator 411. Data output from the residual calculator 411 is supplied to other units (not shown in the figure).

The encoding process performed by the encoding apparatus 410 configured in the above-described manner is described below.

In the frame memories 414-1 to 414-4, as described above, frames N−1 to N−4 are respectively stored. The pixel value of a pixel at a particular position in the frame N−1 is denoted as pixel value X₁. Similarly, the pixel value of a pixel at the same position in the frame N−2 as the position of the above-described pixel in the frame N−1 is denoted as pixel value X₂, the pixel value of a pixel at the same position in the frame N−3 is denoted as pixel value X₃, and the pixel value of a pixel at the same position in the frame N−4 is denoted as pixel value X₄. The pixel value of a pixel at the same position in the frame of interest is denoted as pixel value X₀.

Note that as described above, the pixel value X₀, the pixel value X₁, the pixel value X₂, the pixel value X₃, and the pixel value X₄ are located at the same position (coordinates) in the respective frames.

Prediction coefficients are calculated using frames N−1 to N−4 (stored in the frame memories 414-1 to 414-4), and the frame N of interest is predicted from the frames N−1 to N−3 using the calculated prediction coefficients.

The calculation of the prediction coefficients is performed in accordance with equation (9) shown below.
X₁=a₄X₄+a₃X₃+a₂X₂ (9)
where a₄, a₃, and a₂ are prediction coefficients. a₄, a₃, and a₂ are determined so as to satisfy equation (9) (which is linear in the present example). That is, the prediction coefficients are coefficients by which to predict the frame N−1 from the frames N−4 to N−2.

A plurality of values may be given for each prediction coefficient from the pixel values X₂, X₃, and X₄, or from feature quantity (class code) determined from other pixel values in past frames. For example, the mean value M of the pixel values X₂, X₃, and X₄ is calculated, and the prediction coefficients are classified by a class code CL determined so as to satisfy (10) described below, where CL is an integer number (first classification method). When pixel values can take a value in the range from 0 to 255, CL takes an integer number in the range from 0 to 15.
16·CL<=M <16·(CL+1) (10)
In another example, CL may be given by equations (11) to (13) (second classification method).
C₁=X₄−X₃+5 (11)
C₂=X₃−X₂+5 (12)
CL=11·C₁+C₂ (13)
In equation (11), C₁ is set to 0 if C₁ is negative, and C₁ is set to 10 if C₁ is larger than 10 (same goes for C₂).

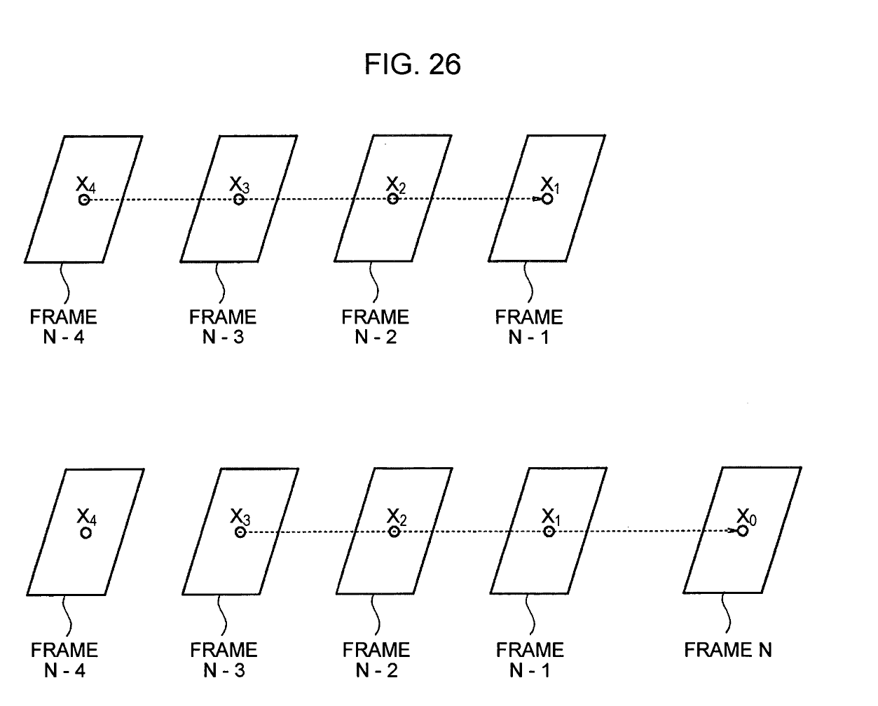

Thus, as shown in an upper area of FIG. 26, the pixel value X₁ in the frame N−1 is predicted from the pixel values X₄, X₃, and X₂ of the respective past frames N−4 to N−2. After the prediction coefficients are determined in the above-described manner, the pixel value X₀ in the frame N of interest is predicted using the prediction coefficients. More specifically, as shown in a lower area of FIG. 26, the pixel value X₀ in the frame N of interest is calculated using the pixel values X₃, X₂, and X₁ of the respective frames N−3 to N−1 according to equation (14).
X₀=a₄X₃+a₃X₂+a₂X₁ (14)

In case where a plurality of values are prepared for prediction coefficients depending on the feature quantity (class code), the feature quantity of the frame of interest is calculated in a similar manner to. For example, when the first classification method is used, the average value M of the pixel values X₁, X₂, and X₃ is calculated.

When the second classification method is used, CL is given by equations (15) to (17).
C₁=X₃−X₂+5 (15)
C₂=X₂−X₁+5 (16)
CL=11·C₁+C₂ (17)
The prediction process is performed by using prediction coefficients corresponding to the calculated feature quantity. Therefore, it is not necessary to send the class code CL to decoding apparatus, because CL can be calculated from the past frames as with prediction coefficients.

Thus, prediction coefficients are determined from past frames, and the frame of interest is predicted using the prediction coefficients, and the residuals between the predicted frame and the true frame are encoded and transmitted to a decoding apparatus at a receiving end.

Thus, as with the encoding apparatus 10 according to the first embodiment, encoding is performed and encoded data is transmitted. In the first embodiment described above, as explained with reference to FIG. 2, the learning unit 61 calculates prediction coefficients, the prediction unit 62 performs prediction using the calculated prediction coefficients, and the encoding unit 63 encodes the residual between the predicted value and the true value. Similarly, in the encoding apparatus 410 according to the second embodiment, prediction coefficients are calculated in accordance with equation (9), prediction is performed according to equation (10) using the prediction coefficients, and the residual between the predicted value and the true value is encoded.

As described above, the second embodiment is similar to the first embodiment in that learning, prediction, and encoding are performed.

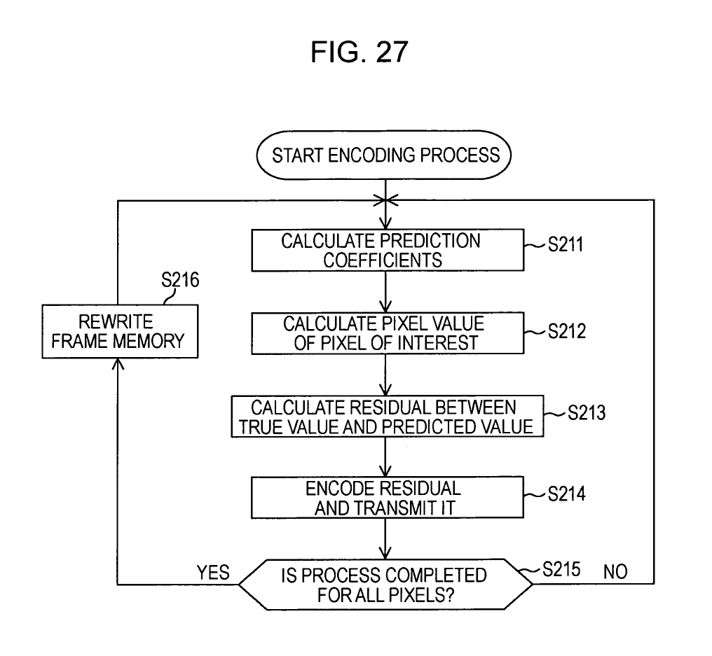

The operation of the encoding apparatus 410 that performs encoding by prediction is described below with reference to a flow chart shown in FIG. 27.

In step S211, the prediction coefficients are calculated by the prediction coefficient calculator 415 as described above with reference to the illustration in the upper area in FIG. 26. More specifically, the prediction coefficients are determined such that the pixel value in the frame N−1 stored in the frame memory 414-1 can be determined from the pixel values of respective frames N−4 to N−2 stored in the frame memories 414-4 to 414-2 using the prediction coefficients.

In step S212, the linear predictor 412 calculates the predicted value of the pixel of interest in the frame N of interest. More specifically, as described above with reference to the illustration in the lower area in FIG. 26, the predicted value of the pixel of interest is calculated, according to equation (10), from the pixel values of the frames N−1 to N−3 stored in the respective frame memories 414-1 to 414-3 using the prediction coefficients calculated in step S211. Note that the value calculated in this manner will be referred to simply as the predicted value.

In step S213, the residual calculator 411 calculates the residual between the predicted value and the true value. Note that the term “true value” is used herein to describe the value of the pixel of interest in the frame of interest input to the residual calculator 411. In step S213, the residual between the predicted value and the value (true value) of the pixel of interest in the input frame of interest is calculated.

In step S214, the residual calculated in step S213 is encoded and transmitted to an apparatus or the like which is not shown in FIG. 25.

In step S215, it is determined whether the process is completed for all pixels in the frame N of interest. If it is determined in step S215 that the process is not yet completed for all pixels, the processing flow returns to step S211 to repeat the process from step S211. This process is performed repeatedly until encoding is performed for all pixels in the frame N of interest.

On the other hand, if the answer to step S215 is that the process is completed for all pixels, the processing flow proceeds to step S216 to update the frames stored in the storage unit 433. More specifically, the frame N of interest is stored as a new frame N−1 into the frame memory 414-1, the old frame N−1 stored in the frame memory 414-1 is stored as a new frame N−2 into the frame memory 414-2, the old frame N−2 stored in the frame memory 414-2 is stored as a new frame N−3 into the frame memory 414-3, and the old frame N−3 stored in the frame memory 414-3 is stored as a new frame N−4 into the frame memory 414-4.

When the process in step S216 is completed, the processing flow returns to step S211 to repeat the process from step S211. The encoding process described above is performed repeatedly as long as a frame to be encoded is input. When no more frame to be encoded is input, an interrupt occurs and the encoding process is ended.

In the present embodiment, as described above, data stored in the frame memory 414 is updated by shifting data from one frame memory to another. Alternatively, an oldest frame may be deleted, and a new frame may be stored in a frame memory in which the deleted frame was stored.

In the encoding according to the present embodiment, as described above, a second frame (for example, the frame N−1 stored in the frame memory 414-1 shown in FIG. 25) is predicted from a first frame (for example, the frames N−2 to N−4 stored in the frame memory 414-2 to 414-4 shown in FIG. 25), and prediction coefficients are calculated on the basis of the prediction. A predicted image is then produced using the calculated prediction coefficients and a third frame (for example, the frames N−1 to N−3 stored in the respective frame memories 414-1 to 414-3).

The residual between a current frame (frame N) to be encoded and the resultant predicted image is calculated, the residual is encoded, and the encoded residual is transmitted to a decoding apparatus.

As described above, prediction coefficients are determined from past frames, the current frame is predicted using the calculated prediction coefficients, and the residual between the predicted value and the true value is calculated, the residual is encoded, and the resultant encoded residual is transmitted to the decoding apparatus. Because the residual is small in data size, it is possible to minimize the data size of data transmitted to the decoding apparatus. In other words, high-efficiency encoding can be achieved.

Configuration and Operation of Decoding Apparatus

A decoding apparatus, which decodes encoded data received from the encoding apparatus 410, is described below. FIG. 28 shows an example of a configuration of the decoding apparatus.

As shown in FIG. 28, the decoding apparatus 430 includes an adder 431, a linear predictor 432, a storage unit 433, and a prediction coefficient calculator 435. The storage unit 433 includes frame memories 434-1 to 434-4. That is, the decoding apparatus 430 shown in FIG. 28 is configured so as to be capable of storing four frames.

In the decoding apparatus 430 shown in FIG. 28, data flows as follows. Image data of a frame to be processed (decoded) is input to the adder 431. In the storage unit 433, frames which have already been decoded are stored.

A frame being processed is denoted as a frame of interest or a frame N−1. In the frame memory 434-1, a frame N−1, which is one frame before the frame N, is stored. In the frame memory 434-2, a frame N−2, which is two frames before the frame N, is stored. In the frame memory 434-3, a frame N−3, which is three frames before the frame N, is stored. In the frame memory 434-4, a frame N−4, which is four frames before the frame N, is stored.

The frames stored in the storage unit 433 are supplied to the linear predictor 432 and the prediction coefficient calculator 435, as required. More specifically, data from the frame memories 434-1 to 434-3 are supplied to the linear predictor 432, and data from the frame memories 414-1 to 414-4 are supplied to the prediction coefficient calculator 435.

Data output from the prediction coefficient calculator 435 is supplied to the linear predictor 432. Data output from the linear predictor 432 is supplied to the adder 431. Data output from the adder 431 is supplied to other units (not shown in the figure). The data output from the adder 431 (that is, the decoded data) is also supplied to the storage unit 433.

More specifically, the data output from the adder 431 is supplied to one of the frame memories 434-1 to 434-4 in the storage unit 433. Note that each time decoding for one frame is completed, frames stored in the frame memories 434-1 to 434-4 are rewritten such that frames older than the current frame being processed are stored in the respective frame memories 434-1 to 434-4.

The decoding process performed by the decoding apparatus 430 configured in the above-described manner is described below. The decoding process performed by the decoding apparatus 430 is similar to the decoding process performed by the decoding apparatus 410 in that prediction coefficients are calculated from past frames (which have already been decoded) and the frame of interest (to be decoded) is predicted using the prediction coefficients.

In the following explanation, it is assumed that the same frame N of interest as the same frame N of interest subjected to the encoding process in the encoding apparatus 410 is now being subjected to the decoding process. When the frame N of interest is subjected to the decoding process, the decoding apparatus 430 is in a state in which the decoded frames N−1 to N−4 reside in the respective frame memories 434-1 to 434-4. Note that this state is similar to the state in the frame N of interest is subjected to the encoding process in the encoding apparatus 410.

Thus, the prediction coefficients calculated by the prediction coefficient calculator 435 in the decoding apparatus 430 using the frames N−1 to N−4 stored in the frame memories 434-1 to 434-4 are the same as those calculated by the prediction coefficient calculator 415 in the encoding apparatus 410. Therefore, the predicted value calculated by the linear predictor 434 in the decoding apparatus 430 is the same as the predicted value calculated by the linear predictor 432 in the encoding apparatus 410.

When the adder 431 of the decoding apparatus 430 receives the residual between the true value and the predicted value from the encoding apparatus 410, the adder 431 calculates the true value by adding the residual to the predicted value supplied from the linear predictor 432 thereby performing encoding.

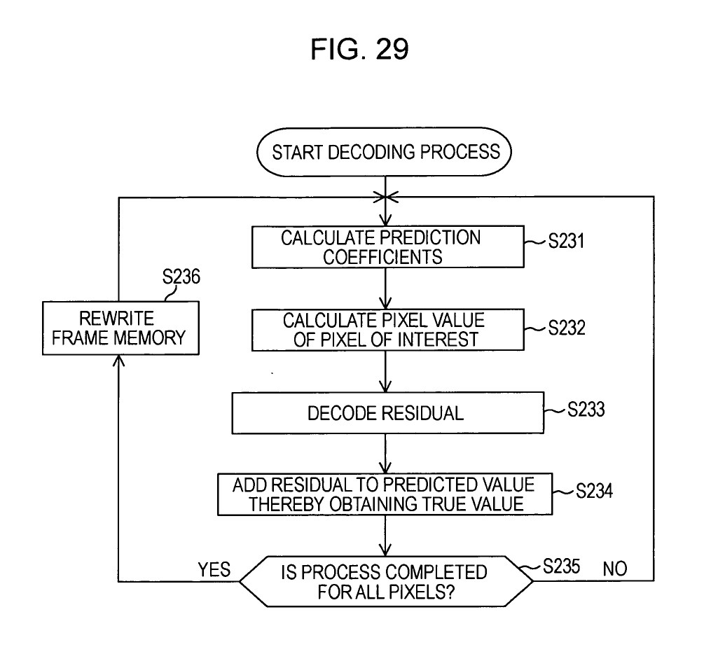

The operation of the decoding apparatus 430 is described below with reference to a flow chart shown in FIG. 29.

In step S231, the prediction coefficients are calculated by the prediction coefficient calculator 435. More specifically, the prediction coefficients are determined such that the pixel value in the frame N−1 stored in the frame memory 434-1 can be determined from the pixel values of respective frames N−4 to N−2 stored in the frame memories 434-4 to 434-2 using the prediction coefficients.

In step S232, the linear predictor 432 calculates the predicted value of the pixel of interest in the frame N of interest. More specifically, the predicted value of the pixel of interest is calculated, according to equation (10), from the pixel values of the frames N−1 to N−3 stored in the respective frame memories 434-1 to 434-3 using the prediction coefficients calculated in step S231. Note that the value calculated in this manner will be referred to simply as the predicted value.

In step S233, the adder 431 decodes the encoded residual received from the encoding apparatus 410. In step S234, the residual decoded in step S233 is added to the predicted value calculated in step S232. The true value obtained as a result of the addition is transmitted to an apparatus which is not show in FIG. 28.

In step S235, it is determined whether the process (decoding) is completed for all pixels in the frame N of interest. If it is determined in step S235 that the process is not yet completed for all pixels, the processing flow returns to step S231 to repeat the process from step S231. This process is performed repeatedly until decoding is performed for all pixels in the frame N of interest.

On the other hand, if the answer to step S235 is that the process is completed for all pixels, the processing flow proceeds to step S236, and the frames stored in the storage unit 433 are updated. More specifically, the frame N of interest is stored as a new frame N−1 into the frame memory 434-1, the old frame N−1 stored in the frame memory 434-1 is stored as a new frame N−1 into the frame memory 434-2, the old frame N−2 stored in the frame memory 434-2 is stored as a new frame N−3 into the frame memory 434-3, and the old frame N−3 stored in the frame memory 434-3 is stored as a new frame N−4 into the frame memory 434-4.

When the process in step S236 is completed, the processing flow returns to step S231 to repeat the process from step S231. The decoding process described above is performed repeatedly as long as a frame to be decoded is input. When no more frame to be decoded is input, an interrupt occurs and the decoding process is ended.

Although in the present embodiment, data stored in the frame memory 434 is updated by shifting data from one frame memory to another, an oldest frame may be deleted and a new frame may be stored in a frame memory in which the deleted frame was stored.

In the decoding process according to the present embodiment, as described above, a second frame (for example, the frame N−1 stored in the frame memory 434-1 shown in FIG. 28) is predicted from a first frame (for example, the frames N−2 to N−4 stored in the frame memory 434-2 to 434-4 shown in FIG. 28), and prediction coefficients are calculated on the basis of the prediction. A predicted image is then produced using the calculated prediction coefficients and a third frame (for example, the frames N−1 to N−3 stored in the respective frame memories 434-1 to 434-3).

The residual produced by the encoding apparatus 410 by decoding the encoded residual supplied from the encoding apparatus 410 is then added to the predicted image thereby obtaining a decoded current frame (frame N).

Thus, the prediction coefficients are calculated using past (decoded) frames, the frame to be reproduced is predicted using the calculated prediction coefficients, and the residual is added to the predicted value thereby obtaining the decoded frame. Note that the residual transmitted from the encoding apparatus to the decoding apparatus is not large in data size, and thus the encoding apparatus can encode it at a high compression ratio into a form which can be decoded by the decoding apparatus.

The above-described encoding and decoding scheme according to the present embodiment allows it to predict as small a change as ±1 without needing additional information, and thus it is possible to achieve high encoding efficiency. The capability of predicting as small a change as ±1 also makes it possible to remove noise at a very low level, which would otherwise be treated as white noise.

As can be seen from FIG. 25 or 28, the encoding apparatus 410 and the decoding apparatus 430 can be realized in a simple form. This allows the encoding apparatus 410 or the decoding apparatus 430 to be easily embedded in an existing apparatus or an apparatus which will be newly produced. Although the encoding apparatus 410 and the decoding apparatus 430 are simple in configuration, they can provide great advantages as described above.

In the embodiments descried above, it is assumed that four frames are stored. Alternatively, a smaller or a greater number of frames (for example, five or six frames) may be stored, and prediction coefficients and a predicted value may be produced using them. The number of frames used to produce the prediction coefficients and the predicted value may be determined experimentally so that resultant residuals can be minimized.

In the embodiments described above, not only prediction coefficients, but also code assignment may be determined from past frames. In this case, according to the distribution of residuals which are differences between true values and predicted values determined using calculated prediction coefficients, code assignment is determined, for example, using Huffman code. The residual of current frame is then encoded by using determined code assignment. Note that when a plurality of sets of prediction coefficient values are used, the code assignment is determined for each set.

In the embodiments described above, the number of stored frames may be limited to two, and a prediction coefficient may be preliminary determined. In a special case in which the prediction coefficient is set to 1.0, pixel values in a frame immediately before the frame of interest are directly used as predicted values (this mode is called a hold-last-value mode).

In the embodiments described above in which four frames are stored, when processing is performed for first four frames in the encoding apparatus 410 or the decoding apparatus 430, as many frames as needed in the processing have not yet been stored in the storage unit 413 (or the storage unit 433).

In the first embodiment, to avoid the above problem, initial data is stored in the storage unit 413 (or the storage unit 433) in the initial state. Similarly, in the second embodiment, as in the first embodiment, initial data for processing first four frames at the beginning of the process may be prepared.

The encoding apparatus and the decoding apparatus may be disposed as separate apparatuses or may be disposed integrally. In the latter case, the resultant apparatus has both capabilities of encoding data and decoding encoded data.

Storage Medium The sequence of processing steps described above may be performed by means of hardware or software. When the processing sequence is executed by software, a program forming the software may be installed onto a computer which is provided as dedicated hardware or may be installed onto a general-purpose computer capable of performing various processes in accordance with various programs installed thereon.

An example of such a program storage medium usable for the above purpose is a removable medium, such as the removable medium 211 shown in FIG. 14, on which a computer-executable program is stored and which is supplied to a user separately from a computer. Specific examples include a magnetic disk (such as a floppy disk), an optical disk (such as a CD-ROM (Compact Disk-Read Only Memory) and a DVD (Digital Versatile Disk)), a magnetooptical disk (such as an MD (Mini-Disc)), and a semiconductor memory. A program may also be supplied to a user by preinstalling it on the built-in ROM 202 or the storage unit 208 such as a hard disk disposed in the computer. The program may be stored into the program storage medium via a wire communication medium such as a local area network or the Internet or via a wireless communication medium such as digital broadcasting, using the communication unit 209 serving as an interface such as a router or a modem.

In the present description, the steps described in the program stored in the program storage medium may be performed either in time sequence in accordance with the order described in the program or in a parallel or separate fashion.

In the present description, the term “system” is used to describe the entirety of an apparatus including a plurality of sub-apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. An encoding apparatus configured to encode input image data including a plurality of frames, comprising:
prediction coefficient generation means for generating a prediction coefficient for use in prediction of a second frame from a first frame;
image prediction means for generating a predicted image from a third frame by using the prediction coefficient;
residual generation means for determining a residual component between a current frame to be encoded and the predicted image; and
output means for outputting the residual component in the form of encoded data,
wherein the first to third frames are frames which occurred, before the occurrence of the current frame, as frames to be encoded.

2. The encoding apparatus according to claim 1, wherein the second frame and the third frame are the same frame.

3. The encoding apparatus according to claim 1, further comprising:
motion vector detection means for detecting a motion vector from the first frame and the second frame;
motion vector code assigning means for gathering motion vectors detected by the motion vector detection means and assigning codes to the motion vectors; and
motion vector encoding means for detecting a motion vector of the current frame with respect to the third fame and encodes the detected motion vector according to the code assignment determined by the motion vector code assigning means,
wherein the output means outputs, in addition to the encoded data of the residual component, the motion vector encoded by the motion vector encoding means.

4. The encoding apparatus according to claim 1, wherein the prediction coefficient generation means includes:
extraction means for extracting pixels from the first frame and the second frame;
detection means for detecting a class from the pixels extracted by the extraction means; and
normal equation generation means for generating a normal equation associated with the pixels extracted by the extraction means for each class detected by the detection means,
whereby the prediction coefficient is generated by solving the normal equation.

5. The encoding apparatus according to claim 1, wherein
the image prediction means includes extraction means for extracting pixels from the first frame and the second frame,
whereby the image prediction means generates the predicted image from the pixels extracted by the extraction means by using the prediction coefficient.

6. The encoding apparatus according to claim 1, further comprising:
extraction means for extracting pixels from the first frame and the second frame;
detection means for detecting a class from the pixels extracted by the extraction means;
storage means for calculating the residual between the predicted image and the second frame and storing a residual distribution determined for each class detected by the detection means; and
residual code assigning means for assigning codes to the residuals of respective classes according to the residual distributions of respective classes stored in the storage means.

7. The encoding apparatus according to claim 6, wherein the output means converts the residual component into encoded data according to the code assignment determined by the residual code assigning means.

8. The encoding apparatus according to claim 1, wherein the first frame and the third frame are each image data of one or a plurality of frames.

9. The encoding apparatus according to claim 1, wherein the prediction coefficient generation means generates prediction coefficients by generating a linear equation from the first frame and the second frame and determining the coefficients that satisfy the generated linear equation.

10. An encoding method, in an encoding apparatus, of encoding input image data including a plurality of frames, comprising:
generating a prediction coefficient for use in prediction of a second frame from a first frame;
generating a predicted image from a third frame by using the prediction coefficient;
determining a residual component between a current frame to be encoded and the predicted image; and
converting the residual component into encoded data,
wherein the first to third frames are frames which occurred, before the occurrence of the current frame, as frames to be encoded.

11. A program executable by a computer to perform an encoding process, in an encoding apparatus, of encoding input image data including a plurality of frames, comprising:
generating a prediction coefficient for use in prediction of a second frame from a first frame;
generating a predicted image from a third frame by using the prediction coefficient;
determining a residual component between a current frame to be encoded and the predicted image; and
converting the residual component into encoded data,
wherein the first to third frames are frames which occurred, before the occurrence of the current frame, as frames to be encoded.

12. A decoding apparatus configured to decode input image data including a plurality of frames, comprising:
prediction coefficient generation means for generating a prediction coefficient for use in prediction of a second frame from a first frame;
image prediction means for generating a predicted image from a third frame by using the prediction coefficient;
residual decoding means for decoding an encoded residual component between a current frame to be decoded and the predicted image; and
output means for adding the decoded residual component to the predicted image and outputting the result,
wherein the first to third frames are frames which were decoded temporally before the current frame.

13. The decoding apparatus according to claim 12, wherein the second frame and the third frame are the same frame.

14. The decoding apparatus according to claim 12, further comprising:
motion vector detection means for detecting a motion vector from the first frame and the second frame;
motion vector code assigning means for gathering motion vectors detected by the motion vector detection means and assigning codes to the motion vectors; and
motion vector decoding means for decoding encoded motion vector data according to the code assignment determined by the motion vector code assigning means.

15. The decoding apparatus according to claim 12, wherein the prediction coefficient generation means includes:
extraction means for extracting pixels from the first frame and the second frame;
detection means for detecting a class from the pixels extracted by the extraction means; and
normal equation generation means for generating a normal equation associated with the pixels extracted by the extraction means for each class detected by the detection means,
whereby the prediction coefficient is generated by solving the normal equation.

16. The decoding apparatus according to claim 12, wherein
the image prediction means includes extraction means for extracting pixels from the first frame and the second frame,
whereby the image prediction means generates the predicted image from the pixels extracted by the extraction means by using the prediction coefficient.

17. The decoding apparatus according to claim 12, further comprising:
extraction means for extracting pixels from the first frame and the second frame;
detection means for detecting a class from the pixels extracted by the extraction means;
storage means for calculating the residual between the predicted image and the second frame and storing a residual distribution determined for each class detected by the detection means; and
residual code assigning means for assigning codes to the residuals of respective classes according to the residual distributions of respective classes stored in the storage means,
wherein residual decoding means decodes the encoded residual component according to the codes assigned by the residual code assigning means.

18. The decoding apparatus according to claim 12, wherein the first frame and the third frame are each image data of one or a plurality of frames.

19. The decoding apparatus according to claim 12, wherein the prediction coefficient generation means generates prediction coefficients by generating a linear equation from the first frame and the second frame and determining the coefficients that satisfy the generated linear equation.

20. A decoding method, in a decoding apparatus, of decoding input image data including a plurality of frames, comprising:
generating a prediction coefficient for use in prediction of a second frame from a first frame;
generating a predicted image from a third frame by using the prediction coefficient;
decoding an encoded residual component between a current frame to be decoded and the predicted image; and
adding the decoded residual component to the predicted image;
wherein the first to third frames are frames which were decoded temporally before the current frame.

21. A program executable by a computer to perform a decoding process, in a decoding apparatus, of decoding input image data including a plurality of frames, comprising:
generating a prediction coefficient for use in prediction of a second frame from a first frame;
generating a predicted image from a third frame by using the prediction coefficient;
decoding an encoded residual component between a current frame to be decoded and the predicted image; and
adding the decoded residual component to the predicted image;
wherein the first to third frames are frames which were decoded temporally before the current frame.

22. A storage medium in which a program according to one of claims 11 to 21 is stored.

23. An encoding apparatus configured to encode input image data including a plurality of frames, comprising:
a prediction coefficient generation unit configured to generate a prediction coefficient for use in prediction of a second frame from a first frame;
an image prediction unit configured to generate a predicted image from a third frame by using the prediction coefficient;
a residual generation unit configured to determine a residual component between a current frame to be encoded and the predicted image; and
an output unit configured to output the residual component in the form of encoded data,
wherein the first to third frames are frames which occurred, before the occurrence of the current frame, as frames to be encoded.

24. A decoding apparatus configured to decode input image data including a plurality of frames, comprising:
a prediction coefficient generation unit configured to generate a prediction coefficient for use in prediction of a second frame from a first frame;
an image prediction unit configured to generate a predicted image from a third frame by using the prediction coefficient;
a residual decoding unit configured to decode an encoded residual component between a current frame to be decoded and the predicted image; and
an output unit configured to add the decoded residual component to the predicted image and outputting the result,
wherein the first to third frames are frames which were decoded temporally before the current frame.
